(19) United States
(12) Patent Application Publication
(10) Pub. No.: US 2012/0086693 A1
(43) Pub. Date: Apr. 12, 2012

(54) Method for Driving Electrochemical Display Device, and Information Display Apparatus

(76) Inventors: Tomoo Izumi, Osaka (JP); Hiroko Ohmori, Kyoto (JP)

(21) Appl. No.: 13/378,016

(22) PCT Filed: May 19, 2010
(86) PCT No.: PCT/JP2010/058418

§ 371 Date: Dec. 13, 2011

(30) Foreign Application Priority Data
Jun. 16, 2009 (JP) 2009-143156

(51) Int. Cl. G09G 5/00

(52) U.S. Cl. 345/211

(57) ABSTRACT

A method is provided for driving an electrochemical display element. An apparatus employing the method is also provided. The method comprises a blackening step for depositing a metal by applying a blackening pulse to a pixel of the electrochemical device, and a whitening step for dissolving the deposited metal by application of a whitening pulse. When the display at the electrochemical display device is being updated, the duration time of application and/or voltage of application of the whitening pulse is adjusted in accordance with the time elapsed since the deposition of the metal in the blackening step before the update in the whitening step. This method enables sufficient whitening of the pixel of the electrochemical display device, excellent durability, and shortening of the time for update.

### TECHNICAL FIELD

The present invention relates to a method for driving an electrochemical display device and relates to an information display apparatus.

### BACKGROUND ART

In recent years, there is need for display devices which have excellent visibility and low power consumption. The generally used display devices which emit light by themselves or modulate light from a self-light-emitting device such as a CRT, a PDP, and a LCD are bright and easy to watch, but they have a problem of large power consumption. From the view point of low power consumption, it is desired that the display device has a memory property which maintains the display without electric power and the display device has low drive voltages.

As the display devices having these properties, known are: an electro chromic display device (hereinafter, referred to as “ECD device”) which employs a reversible change in a light absorption state caused by a redox reaction on an electrode; and an electro deposition display device (hereinafter, referred to as “ED device”) which employs deposition and elution of metal from and into electrolyte liquid containing metal or compound whose chemical structure includes metal.

The ECD device and the ED device have a principle of display which employs a redox reaction on the electrode and utilizes change in light absorption by a reactant alone, and the devices do not need an additional element such as a polarizer or a backlight; thus the devices are advantageous display devices for cost reduction and streamlining of the production process.

Among these devices, the ED device has features that it can be driven by such a low voltage as 3V or lower, has a simple cell structure, and has an excellent display property of bright paper-like white and deep black, and further has excellent features that it can display multiple tones, and does not need electric power to maintain the display due to its a memory property.

Patent document 1 discloses the method for driving the ED device in which multiple tones are displayed by controlling the time period to apply a deposition voltage for depositing silver.

In order to display on the ED device, first a whitening pulse for dissolving metal into the electrolyte liquid is applied so as to initialize all the pixels to be white, and then blackening pulse for depositing metal on the electrodes is applied to the required pixels so as to display black. In the case of updating the displayed image, it is general that after initializing all the pixels to be white and only the required pixels are then made to display black.

### RELATED ART DOCUMENT

### Patent Document

Patent Document: Japanese Registered Patent 3985667

### SUMMARY OF THE INVENTION

### Object of the Invention

However, regarding the ED device, the resolvability of the deposited metal depends on the variation of production condition, change of the ambient environment such as temperature or humidity, or a temporal change in material. Therefore, to solve the issue of residual black display when making all the pixels display white, setting can be done as “an application time of a whitening pulse=a set time period (designed value) needed for the deposited metal to supposedly perfectly dissolve+a margin α.”

However, if the margin α is too long, the whitening pulse is kept applied after the deposited metal has perfectly dissolved, with the result that an unintended electrochemical reaction occurs in the ED device, and thereby lowering the durability.

In view of the aforementioned issues, the present invention has been made, and an object of the present invention is to provide a method for driving the electrochemical display device and to provide an information display apparatus in which the pixels of the electrochemical display device can be sufficiently whitened, the durability is excellent, and the time period for updating the display can be shortened.

### Means for Solving the Object

In order to accomplish an object of the present invention, a method for driving an electrochemical display device which includes a plurality of pixels arranged in a two-dimensional matrix, wherein display is performed by depositing metal in the pixels or by dissolving the metal deposited in the pixels by using an electrochemical reaction, the method comprises:

a blackening step for depositing the metal in the pixels by applying a blackening pulse to the pixels; and

a whitening step for dissolving the metal deposited in the pixels by applying a whitening pulse to the pixels,

wherein in the whitening step, one of or both of a voltage of the whitening pulse and an application time period of the whitening pulse are changed, depending on a time period having elapsed since the metal was deposited in the pixels in the blackening step.

Further, in order to accomplish an object of the present invention, an information display apparatus comprises:

a display section including an electrochemical display device, the electrochemical display device having a plurality of pixels arranged in a two-dimensional matrix, wherein an display operation is performed by depositing metal in the pixels or by dissolving the metal deposited in the pixels, by using an electrochemical reaction; and

a display control section configured to control the display operation of the display section, the display control section applying a blackening pulse to the pixels when depositing metal in the pixels, and applying a whitening pulse to the pixels when dissolving the metal deposited in the pixels, and the control section changing one of or both of a voltage of the whitening pulse and an application time period of the whitening pulse, depending on a time period having elapsed since the metal was deposited in the pixels by applying the blackening pulse.

### Advantage of the Invention

The present invention provides a method for driving the electrochemical display device and provides an information display apparatus, and the method comprise: a blackening step for applying a blackening pulse for depositing metal in the electrochemical display device; and a whitening step for applying a whitening pulse for dissolving the deposited metal, wherein one of or both of a time period to apply the whitening pulse and an application voltage of the whitening pulse, depending on a time period having elapsed since the metal was deposited in the blackening step, whereby the pixels of the electrochemical display device can be sufficiently whitened, the durability is excellent, and the time period to update the display is shortened.

### BRIEF DESCRIPTION OF THE DRAWINGS

FIG. 1 is an external schematic diagram showing an example of the configuration of an information display apparatus of an embodiment according to the present invention;

FIG. 2 is a circuit block diagram showing an example of the configuration of an information display apparatus of an embodiment according to the present invention;

FIG. 3 is a circuit block diagram showing an example of the configuration of a display section of a first embodiment;

FIG. 4 is a timing chart showing the display operation for updating one page of the display on the display section of the first embodiment;

FIG. 5 is a flow chart showing the updating operation of the display on the pixels of the first embodiment;

FIG. 6 is a timing chart showing the updating operation of the display on the pixels of the first embodiment;

FIG. 7 is a flow chart showing the updating operation of the display on the pixels of a second embodiment;

FIG. 8 is a timing chart showing the updating operation of the display on the pixels of the second embodiment;

FIG. 9 is a flow chart showing the updating operation of the display on the pixels of the second embodiment;

FIG. 10 is a schematic diagram showing an example of a table of a third embodiment;

FIG. 11 is a timing chart showing the updating operation of the display on the pixels of the third embodiment;

FIGS. 12a, 12b, and 12c are schematic diagrams showing the configuration of an ED device for evaluation of Example 1;

FIG. 13 is a schematic diagram showing how to connect lines for the evaluation of Example 1;

FIG. 14 is a schematic diagram showing the cross section of an ED device for evaluation of Example 3;

FIG. 15 is a schematic diagram showing how to connect lines for the evaluation of Example 4;

FIGS. 16a and 16b are schematic diagrams showing the principle of display of the ED device; and

FIG. 17 is a schematic diagram showing how to display multiple tones on the ED device.

### BEST MODE FOR CARRYING OUT THE INVENTION

The present invention is described below with respect to the illustrated embodiments without the present invention being restricted to the embodiments. The same or equivalent portions in the drawings are assigned the same numerals, and the duplicated descriptions may be omitted.

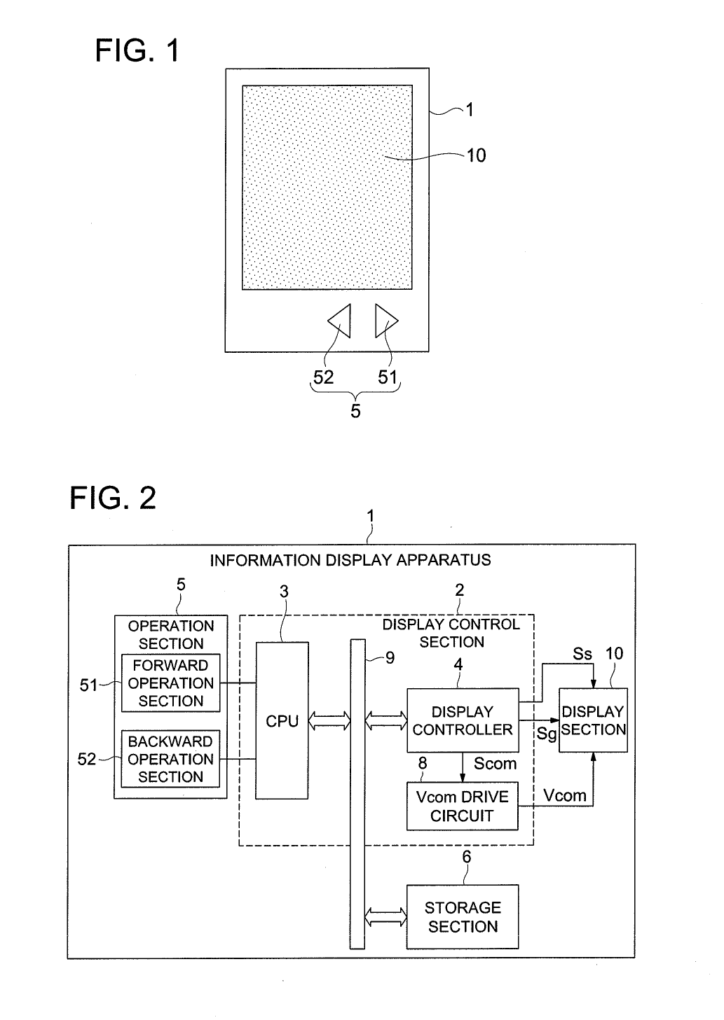

First, an example of the configuration of an information display apparatus according to an embodiment of the present invention will be described with reference to FIGS. 1 and 2. FIG. 1 is an external schematic diagram showing the information display apparatus according to an embodiment of the present invention. FIG. 2 is a block diagram showing the information display apparatus according to the embodiment of the present invention. The configuration of the information display apparatus shown in FIGS. 1 and 2 is common to the first embodiment to the third embodiment to be described latter.

Referring to FIG. 1, an information display apparatus 1 is provided on its surface with a display section 10 constituted by an electro deposition display device (ED device), which is the electrochemical display device, and with an operation section 5. The operation section 5 is made up of a forward operation section 51 and a backward operation section 52 and is used by the user to manipulate the display of the information displayed on the display section 10.

Referring to FIG. 2, the information display apparatus 1 is constituted by a display control section 2, the operation section 5, a storage section 6, a bus 9, and the display section 10. The display control section 2 is made up of a CPU 3, a display controller 4, and a Vcom drive circuit 8. These sections are interconnected directly or through the bus 9.

The CPU 3 extracts the program stored in a ROM of the storage section 6, in a RAM of the storage section 6, and controls according to the program the display operation on the display section 10 through the display controller 4 and the operations on the information display apparatus 1.

The display controller 4 supplies, under the control of the CPU 3, to the display section with a column selection signal Ss and a row selection signal Sg for controlling the display of the information file stored in the storage section 6 on the display section, and supplies with a Vcom drive signal Scom to the Vcom drive circuit 8. The display controller 4 is constituted by a hardware logic circuit such as a CMOS-LSI or a gate allay device, or by a micro computer chip.

The forward operation section 51 and the backward operation section 52 of the operation section 5 is connected to the CPU 3. When the forward operation section 51 or the backward operation section 52 is operated, the display is updated so as to scroll forward or backward the information displayed on the display section 10.

The storage section 6 is constituted by a ROM for storing programs, a RAM where a program is extracted, a memory section for storing information files, and a frame memory for temporarily storing the data for one page displayed on the display section 10, and contributes to the operations of the CPU 3 and the controller 4.

The Vcom drive circuit 8 generates a common voltage Vcom to be applied to a common electrode 113, which will be described later, of the ED device of the display section 10 and supplies the common voltage Vcom to the display section, according to the Vcom drive signal Scom from the display controller 4.

The display section 10 is constituted by an ED device and peripheral circuits and is controlled by the display controller 4 to display the information file stored in the storage section 6.

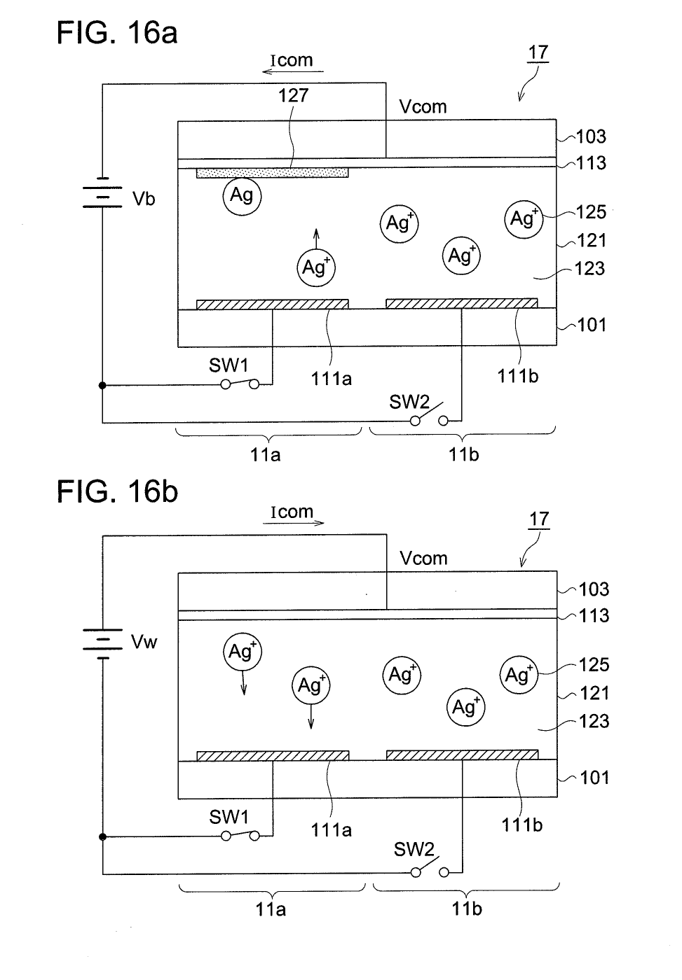

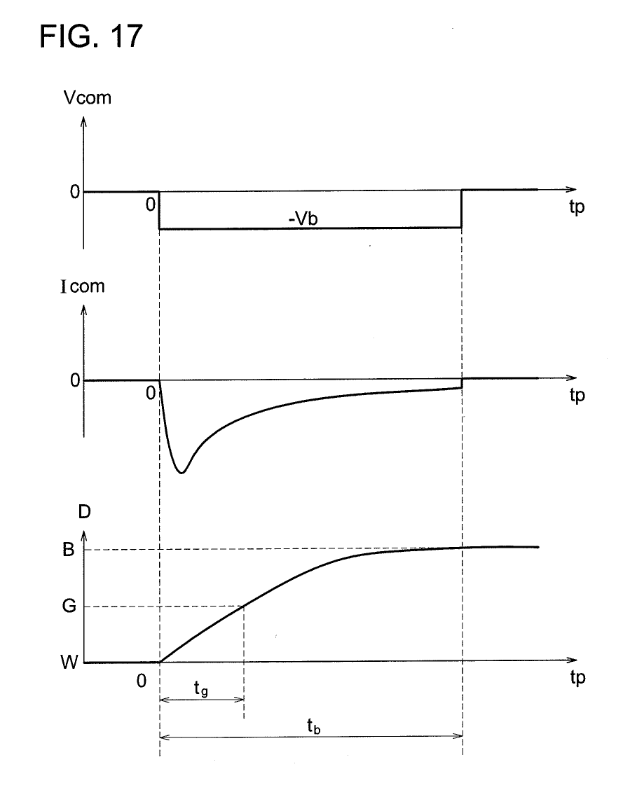

Here, the principle of display of the ED device and how to display multiple tones are briefly described with reference to FIGS. 16a, 16b, and 17. In the description, it is assumed that the ED device is made up of two pixels 11a and 11b.

Referring to FIGS. 16a and 16b, the ED device 17 has a structure in which a electrolyte liquid layer 121, which has silver ions 125 dissolved in electrolyte liquid 123, is sandwiched between a pixel electrodes 111a, 111b and a common electrode 113. The pixel electrodes 111a and 111b are of the pixels 11a and 11b which are provided on a drive substrate 101, and a common electrode 113 is provided under the common substrate 103 and is shared among the pixels 11a and 11b.

For the common electrode 113, a transparent electrode such as ITO (indium tin oxide) electrode is used, and for the pixels electrodes 111a and 111b, chemically stable metal such as silver is used.

Referring to FIG. 16a, when the switch SW1 is turned on, the pixel electrode 111a is supplied with a negative voltage Vb, which is above the threshold, as the common voltage Vcom for the common electrode 113, whereby electrons are injected to make a common current Icom, and the silver layer 127 of the reduced silver ions 125 is deposited at the position, on the common electrode, facing the pixel electrode 111a. When this is observed from the common electrode 113 side, the portion where the silver layer is deposited looks black. At this time, the switch SW2 is off, and no voltage is applied between the common electrode 113 and the pixel electrode 111b; thus the silver layer 127 is not deposited there.

Referring to FIG. 16b, when the pixel electrode 111a is supplied with a positive voltage Vw, which is above the threshold, as the common voltage Vcom for the common electrode 113, the silver layer 127 deposited at the position on the common electrode 113 facing the pixel electrode 111a is oxidized to be the silver ions 125 and dissolved in the electrolyte liquid 123. At this time, the switch SW2 is off, no voltage is applied between the common electrode 113 and the pixel electrode 111b.

The state where the silver layer 127 has changed to the silver ions 125 is transparent when observed from the common electrode 113 side; therefore by coloring the electrolyte liquid 123 white or providing a diffusion layer on the pixel electrode, the device looks white. In this manner, the display can be changed between white and black. By arranging the pixels 11a and 11b of the ED device in a two-dimensional matrix, a two dimensional display can be configured. It should be noted that when the electrolyte liquid 123 is colored in other color than white, other color can be displayed, and a full color display can be realized by arranging the pixels in three primary colors.

In FIG. 16, it is assumed for the sake of explanation that the switches SW1 and SW2 are used to apply voltages to the pixels 11a and 11b. However, in the embodiment, so called an active matrix method is used, in which two TFTs (thin film transistors) are used for one pixel as switches to apply voltages to the pixel.

Next, with reference to FIG. 17, the method will be briefly described in which multiple tone display is performed by controlling the time period to apply a deposition voltage to the pixel electrode.

With reference to FIG. 17, when a negative deposition voltage as the common voltage Vcom for the common electrode 113 is applied, the common current Icom flows from the pixel electrode 111a to the common electrode 113, the current is first large and is then decreasing; thus the silver layer 127 is deposited at the position on the common electrode 113 facing the pixel electrode 111a. By observing the deposited silver layer 127 from the common electrode 113 side, it is perceived that the density D displayed on the pixel 11a changes darker from the white display D by way of the gray display G to the black display B as the application time tp of the voltage Vb elapses.

Therefore, by setting the application time tp of the voltage Vb to the time period tg for the gray display G or to the time tb0 for the black display B, the three-level display of white, gray, and black is realized. When the application time tp of the voltage Vb, that is the density D, is divided more finely, multiple-level display more than three levels is realized.

Although silver is used as metal to be deposited in the above description, metal other than silver can be used.

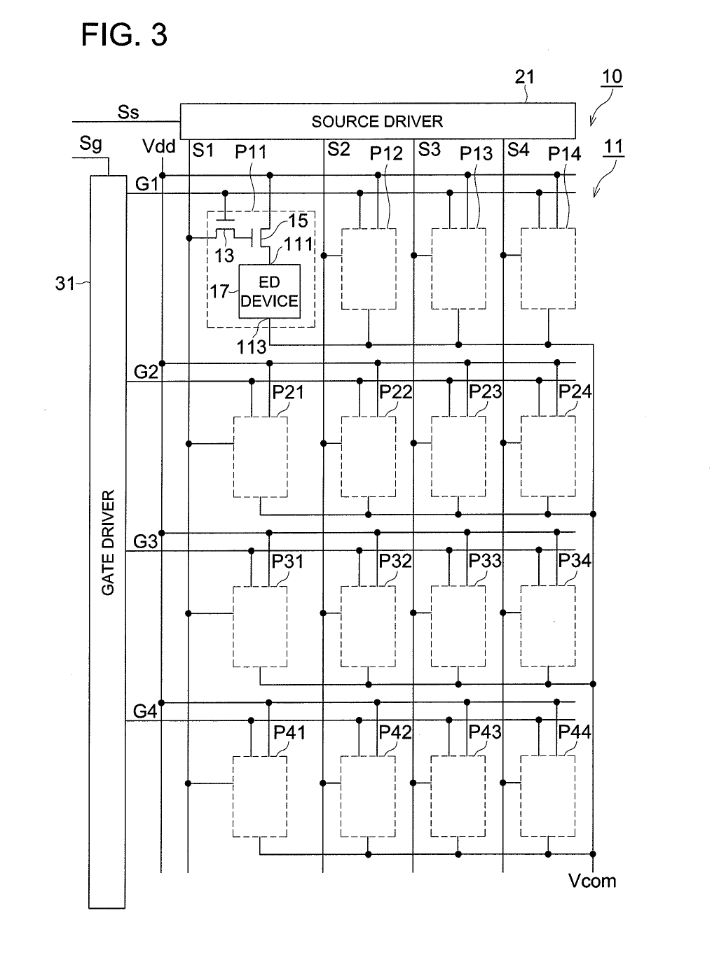

Next, with reference to FIGS. 3 to 6, a first embodiment of the present invention will be described. FIG. 3 is a block circuit diagram showing an example of the configuration of a display section 10 of the first embodiment. For the sake of explanation, taking the lateral arrangement of the pixels 11 as a row and taking the vertical arrangement of the pixels 11 as a column, 4 row×4 column=16 pixels are illustrated, however the display section 10 actually has more pixels 11 constituting the screen. With respect to 16 of the pixels 11, assuming that the pixel 11 at the position of m-th row and n-th column is referred to as the pixel Pmn. For example, the pixel 11 located at the position of 1st row and 1st column is referred to as the pixel P11, and that at the position of 3rd row and 2nd column is referred to as the pixel P32.

Referring to FIG. 3, the display section 10 is constituted by 16 of the pixels 11 (P11-P44), a source driver 21, and a gate driver 31. Each of 16 of the pixels 11 is made up of a selection transistor 13, a drive transistor 15, two TFTs, and an ED device.

The source driver 21 outputs the source signals S1, S2, S3, and S4 to be supplied to the sources of the selection transistors 13 of each column of the display section 10 according to the column selection signal Ss from the display controller 4. The gate driver 31 outputs the gate signals G1, G2, G3, and G4 to be supplied to the gates of the selection transistors 13 of each row of the display section according to the row selection signal Sg from the display controller 4. The drains 13 of the selection transistors 13 are connected to the gates of the drive transistors 15, and the On and Off of the drive transistors 15 are controlled.

One of the gate signals G1 to G4 is sequentially selected by the gate driver 31, and while all the selection transistors 13 of the selected row is on, the source driver 21 supplies the signal to any of the source signals S1 to S4. By repeating the above operation, while scanning the first row to the fourth row of the display section 10, display is performed by controlling the On and Off of the drive transistors.

The sources of the drive transistors 15 are connected to the common pixel voltage Vdd, and the drains of the drive transistors 15 are connected to the pixel electrodes 111 of the ED device 17 of the pixels 11. The common electrode 113 of the ED devices is connected to the same common voltage Vcom from the Vcom drive circuit 8.

By controlling the voltage applied between the common pixel voltage Vdd and the common voltage Vcom, the ED devices of the pixels 11 are made to display white or black.

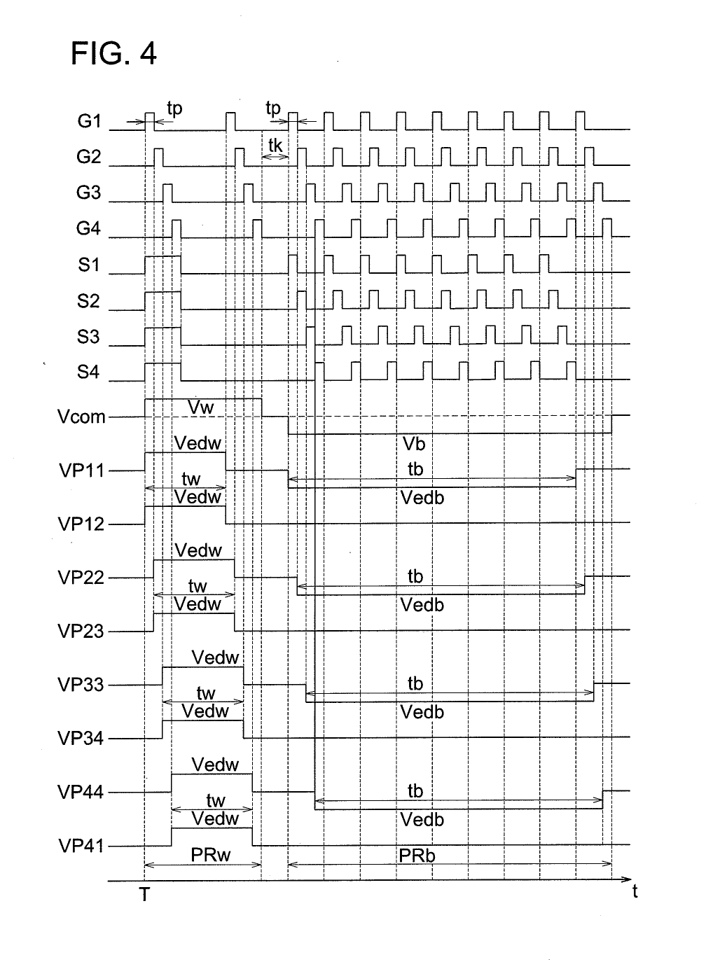

FIG. 4 is a timing chart showing the display operation for updating one page of the display on the display section 10 shown in FIG. 3. In this description, taking it as an example that the pixels P11, P22, P33, and P44 display black and the other pixels 11 display white, FIG. 4 shows an example of the operation of the pixels P11, P22, P33, and P44 in the black display state and the pixels P12, P23, P34, and P41 are in the white display state. As described above in the display using the ED device, all the pixels 11 are first initialized to be white, and then the needed pixels 11 are made to display black.

Referring to FIG. 4, at timing T, the common voltage Vcom is set at the white display voltage Vw for causing the pixel 11 to display white (Vcom=Vw). In this state, each row is scanned with the gate signals G1 to C4 being sequentially tuned on with the pulse width tp. All the source signals S1 to S4 are on while the gate G1 to the gate G4 are being scanned, and the chive transistors 15 of the pixels are tuned on sequentially row by row, whereby the ED device 17 of each pixel is supplied with a whitening pulse voltage Vedw for the white display. Here, the whitening pulse voltage Vedw functions as the application voltage of the whitening pulse of the present embodiment.

After the whitening pulse time tw for the initialization to the white display has elapsed, the gate signals G1 to G4 are sequentially turned on with the pulse with tp, whereby each row is scanned. In this operation, all the source signals S1 to S4 are kept off, the drive transistors 15 of the pixels are sequentially turned off row by row. Here, the whitening pulse time tw functions as the application time period of the whitening pulse of the present embodiment.

By this operation, all the pixels 11 are supplied with the white display voltage Vw for the whitening pulse time tw, and the ED devices 17 of all the pixels 11 are supplied with the whitening pulse voltage Vedw, whereby all the pixels 11 are initialized to the white display. Hear, a whitening pulse Pw is a pulse which has the voltage Vedw and is applied to the ED device 17 of the pixel 11 for the time tw.

Next, in synchronism with the turning off of the gate signal G4, the common voltage Vcom is returned from the white display voltage Vw to the initial voltage. The time period when the common voltage Vcom is kept to be the white display voltage Vw (Vcom=Vw) is the whitening step PRw of the present embodiment.

After the elapse of a predetermined wait time tk, the common voltage Vcom is set to the black display voltage Vb for causing the pixel 11 to display black (Vcom=Vb). However, the predetermined wait time tk may be omitted. In this state, the gate signals G1 to G4 is sequentially turned on with the pulse width tp, whereby the rows are scanned. In this operation, the source signal S1 is on only when the gate signal G1 is on, the source signal S2 is on only when the gate signal G2 is on, the source signal S3 is on only when the gate signal G3 is on, and the source signal S4 is on only when the gate signal G4 is on.

By this operation, the drive transistors 15 of the pixels 11 P11, P22, P33, and P44 are tuned on, whereby the ED devices 17 of the pixels 11 P11, P22, P33, and P44 are supplied with the blackening voltage Vedb for the black display. The drive transistors 15 of the other pixels 11 remain oft whereby no voltage is applied to the ED devices 17.

Assuming here that by repeating the scan of the gate signals G1 to G4 eight times, the ED devices 17 are supplied with the blackening pulse Vedb for the black display for the blackening pulse time tb for the black display, and the black is thus displayed. Dining that period, in synchronism with the scan of the gate signals G1 to G4, the source signals S1 to S4 are also turned on and off.

Following the above operation, the ninth scan of the gate signals G1 to G4 are performed. In this operation, all the source signals S1 to S4 are off, and the drive transistors 15 of the pixels P11, P22, P33, and P44 are sequentially turned off.

By this operation, the pixels P11, P22, P33, and P44 are supplied with the black display voltage Vb for the blackening pulse time tb, whereby the ED devices 17 of the pixels P11, P22, P33, and P44 are supplied with the blackening pulse voltage Vedb, thereby causing the pixels P11, P22, P33, and P44 to display black. The other pixels 11 remain the white display. A blackening pulse Pb here is the pulse which has the voltage Vedb and is applied to the ED device 17 of the pixel 11 for the time tb.

Next, in synchronism with the turning off of the gate signal G4, the common voltage Vcom is turned from the blackening voltage Vb to the initial voltage. The time period when the common voltage Vcom is kept to be the black display voltage Vb is the blackening step PRb of the present embodiment.

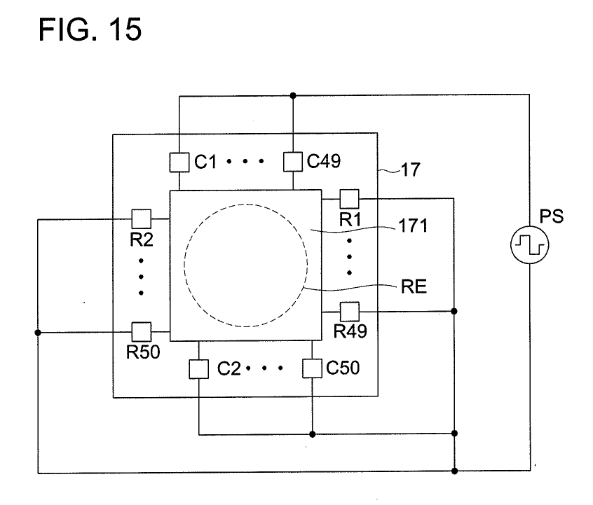

If the source signals are turned off while the gate signals G1 to G4 are being scanned eight times, the corresponding pixels 11 are set to the gray display, and the multiple tone display shown in FIG. 15 is thus realized.

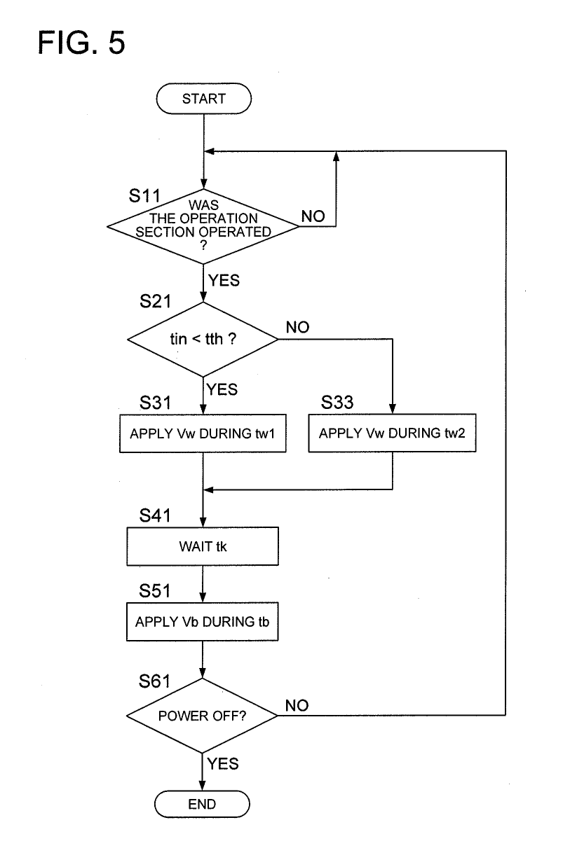

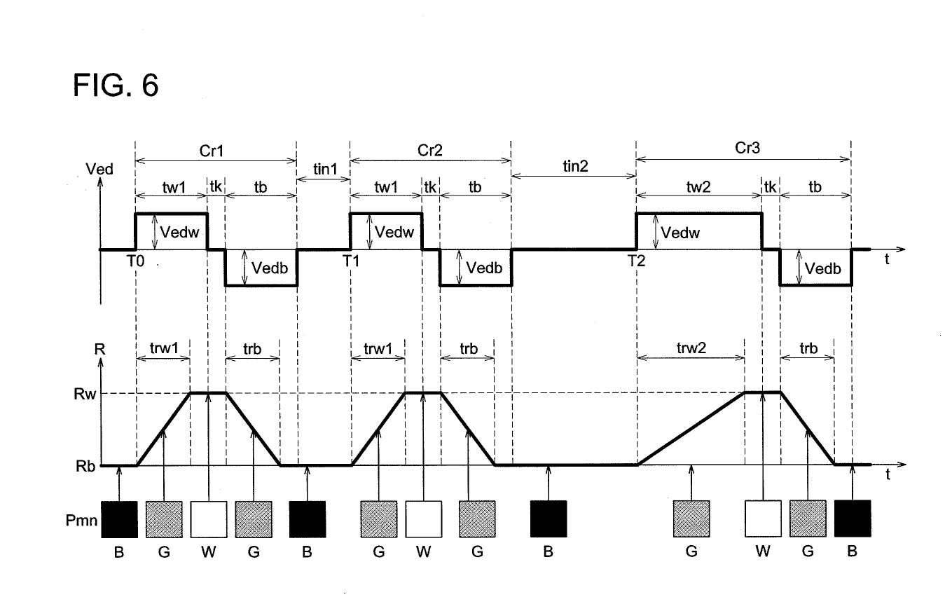

Next, the operation of updating the display of the pixels 11 of the first embodiment is described with reference to FIGS. 5 and 6. FIG. 5 is a flow chart showing the operation of updating the display of the pixels 11 of the first embodiment.

As the elapsed time since the silver was deposited, that is, the elapsed time since the display turned to the black display is longer, the resolvability of the deposited silver gets worse; therefore in order to resolve the deposited silver, it is preferable to extend the whitening pulse time tw or to raise the whitening pulse voltage Vw.

Therefore, in the first embodiment, the elapsed time since the display was last updated, that is, the elapsed time tin (hereinafter, referred to as “display updating interval”) since the silver was last deposited in the blackening step is classified into two parts according to whether tin is shorter than a predetermined time period tth or not; and if tin is shorter than the predetermined time period tth, the whitening pulse time tw is set short, and if tin is longer than or equal to the predetermined time period tth, the whitening pulse time tw is set long. The shorter whitening pulse time tw is referred to as a “first whitening pulse time tw1, and the longer whitening pulse time tw is referred to as a “second whitening time tw2. The white display voltage Vw is kept constant.

Referring to FIG. 5, in step S11, it is checked whether any of the forward operation section 51 and the backward operation section 52 of the operation section 5 was operated or not. If neither one was operated (step S11: No), the process waits in step S11 until the operation is done. If the operation was done (step S11: Yes), it is checked in step S21 whether the display updating interval tin is shorter than the predetermined time period tth of not. If the display updating interval tin is shorter than the predetermined time period tth (step S21: Yes), the white display voltage Vw is applied in step S31 (a first whitening step) to all the pixels P11 for the first whitening pulse time tw1.

If the display updating interval tin is longer than or equal to the predetermined time period tth (step S21: No), the white display voltage Vw is applied in step S33 (a second whitening step) to all the pixels P11 for the second whitening pulse time tw2.

In step S41, the process waits for a predetermined waiting time tk. However, the predetermined waiting time tk may be omitted. Next, in step S51 (a blackening step PRb), only the pixels P11 to be made to display black are supplied with the black display voltage Vb for the blackening pulse time tb, whereby the black display is completed.

In step S61, it is checked whether the information display apparatus is powered off or not. If it is powered off (step S39: Yes), the process is finished as it is. Regarding the ED device, even if the power is cut, the display does not disappear and keeps displaying. If it is not powered off (step S39: No), the process goes back to step S11 and the aforementioned operation is repeated.

FIG. 6 is a timing chart showing the updating operation of the display of the pixels 11 of the first embodiment. In this description, the pixel Pmn which is located at the position of m-row and n-column is taken as an example. In the upper half of FIG. 6, the lateral axis represents time t, and the vertical axis represents the voltage Ved applied to the ED device of the pixel Pmn. In the lower half of FIG. 6, the lateral axis represents time t, and the vertical axis represents the reflectance of the pixel Pmn and the image (the black display B, the gray display G, or the white display W) of the pixel Pm at each time.

The FIG. 6 shows the case that the pixel Pmn is once updated to display black by the updating operation Cr1, and after the updating interval tin (referred to as tin1) which is shorter than the predetermined time period tth, the pixel P11 is updated to display black by the updating operation Cr2, and again, after the updating interval tin (referred to as tin2) which is longer than the predetermined time period tth, the pixel P11 is updated to again display black by the updating operation Cr3.

Referring to FIG. 6, the pixel Pmn is supplied with the white display voltage Vw from the time T0 for the first whitening pulse time tw1, whereby the ED device of the pixel Pmn is supplied with the whitening pulse voltage Vedw. The pixel Pmn is made to display the white display W from the black display B by way of the gray display G in the whitening response time trw1, which is shorter than the first whitening pulse time tw1. In this state, the pixel P11 has a reflectance R which is the reflectance Rw of white.

After the elapse of the predetermined wait time tk, the pixel Pmn is supplied with the black display voltage Vb for the blackening pulse time tb, whereby the ED device 17 of the pixel Pmn is supplied with the blackening pulse voltage Vedb. The pixel Pmn is made to display the black display B from the white display W by way of the gray display G in the blackening response time trb, which is shorter than the blackening pulse time tb. In this state, the pixel Pmn has the reflectance R which is the reflectance Rb of the black display. However, the predetermined wait time tk may be omitted. By the above process, the updating operation of the display of the pixel Pmn to the black display B by the updating operation Cr1 is completed.

After collapse of the display updating interval tint, the display of the pixel Pmn is updated to the black display by the updating step Cr2. In this case, because the display updating interval tin1 is shorter than the predetermined time period tth, the operation of step S31 (a first whitening step) of FIG. 5 is performed, under the condition: the whitening pulse time tw=the first whitening pulse time tw1.

The pixel Pmn is supplied with the white display voltage Vw from time T1 for the first whitening pulse time tw1, whereby the FD device 17 of the pixel Pmn is supplied with the whitening pulse voltage Vedw. The pixel Pmn is made to display the white display W from the black display B by way of the gray display G in the whitening response time trw1, which is shorter than the first whitening pulse time tw1. In this state, the pixel Pmn has a reflectance R which is the reflectance Rw white.

After the elapse of the predetermined wait time tk, the pixel Pmn is supplied with the black display voltage Vb for the blackening pulse time tb, whereby the ED device 17 of the pixel Pmn is supplied with the blackening pulse voltage Vedb. The pixel Pmn is made to display the black display B from the white display W by way of the gray display G in the blackening response time trb, which is shorter than the blackening pulse time tb. In this state, the pixel Pmn has a reflectance R which is the reflectance Rb of the black display. However, the predetermined wait time tk may be omitted. By the above process, the updating operation is completed in which the pixel Pmn is updated to the black display B by the updating operation Cr2 after the elapse of the display updating interval tin1.

Next, after the elapse of the display updating interval tin2, the display of the pixel Pmn is updated to the black display by the updating operation Cr3. In this case, because the display updating interval tin2 is longer than the predetermined time period tth, the operation of step S33 (a second whitening step) of FIG. 5 is performed, under the condition: the whitening pulse time tw=the second whitening pulse time tw2.

The pixel Pmn is supplied with the white display voltage Vw from time T2 for the second whitening pulse time tw2, whereby the ED device 17 of the pixel Pmn is supplied with the whitening pulse voltage Vedw. The pixel Pmn is made to display the white display W from the black display B by way of the gray display G in the whitening response time trw2, which is shorter than the second whitening pulse time tw2. In this state, the pixel Pmn has a reflectance R which is the reflectance Rw of white.

After the elapse of the predetermined wait time tk, the pixel Pmn is supplied with the black display voltage Vb for the blackening pulse time tb, whereby the ED device 17 of the pixel Pmn is supplied with the blackening pulse voltage Vedb. The pixel Pmn is made to display the black display B from the white display W by way of the gray display G in the blackening response time trb, which is shorter than the blackening pulse time tb. In this state, the pixel Pmn has a reflectance R which is the reflectance Rb of the black display. However, the predetermined wait time tk may be omitted. By the above process, the updating operation is completed in which the pixel Pmn is updated to the black display B by the updating operation Cr3 after the elapse of the display updating interval tint.

As described above, according to the first embodiment, the method for driving an ED device and an information display apparatus are provided, by which method and in which apparatus the ED device is sufficiently whitened, and the ED device has excellent durability. The method comprises: a step of depositing metal by applying a blackening pulse to a pixel of the ED device; and a step of dissolving the deposited metal by applying a whitening pulse, wherein in the case of updating the display of the ED device, when the elapse of time (a display updating interval) since the blackening step before the update of display is shorter than the predetermined time, the whitening pulse time is set short (a first whitening step), and when the display updating interval is longer than or equal to the predetermined time, the whitening pulse time is set long (a second whitening step).

In addition, in the case that the display updating interval is shorter than the predetermined time, the whitening pulse time can be set short, thereby providing a method for driving the ED device and an information display apparatus in which the time period for updating the display can be short.

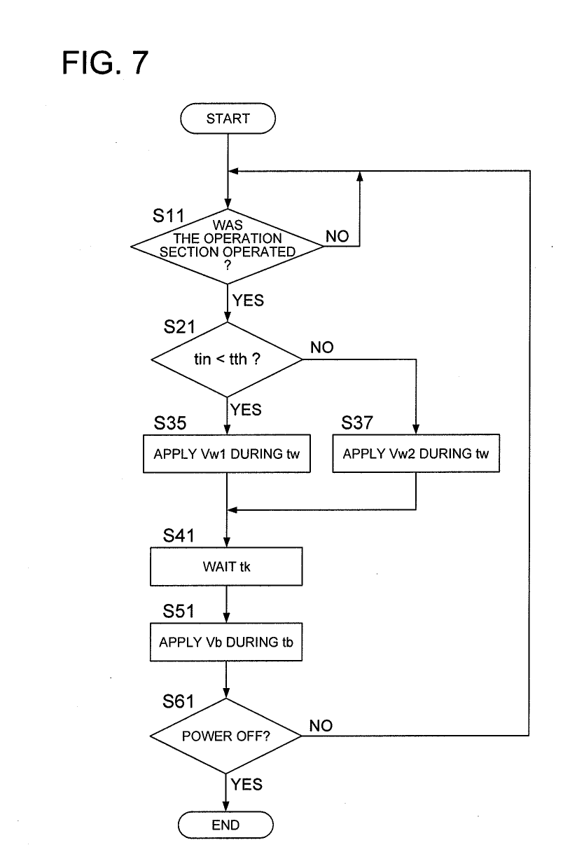

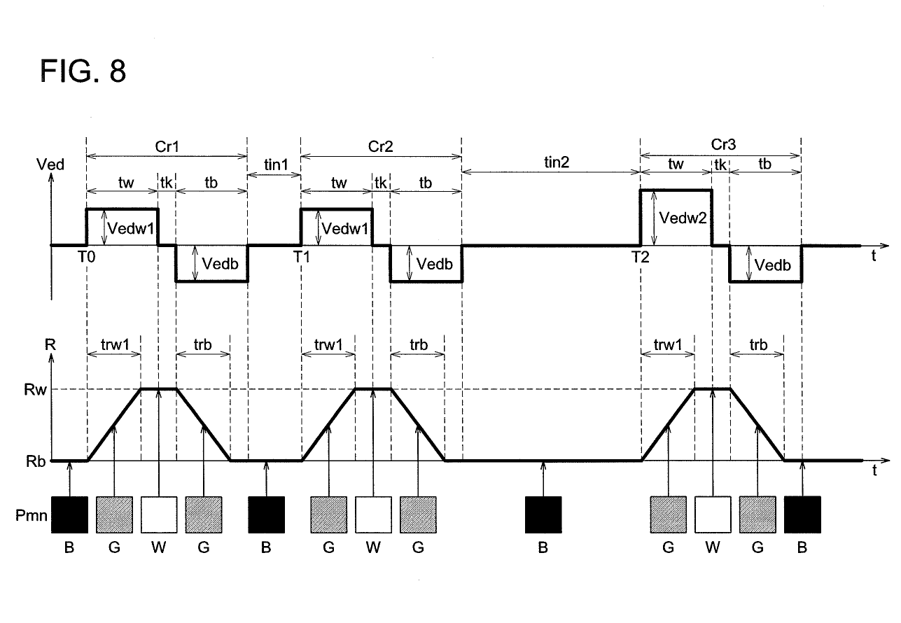

Next, a second embodiment of the present invention is described with reference to FIGS. 7 and 8. FIG. 7 is a flow chart showing an updating operation of the display of the pixel 11 of the second embodiment.

In the second embodiment, the display updating interval tin is classified into two parts according to whether tin is shorter than a predetermined time period tth or not, and if tin is shorter than the predetermined time period tth, the whitening pulse voltage Vedw is set low, and if tin is longer than or equal to the predetermined time period tth, the white display voltage Vw is set high.

The low white display voltage Vw is referred to as a first white display voltage Vw1, the low whitening pulse voltage Vedw is referred to a first whitening pulse voltage Vedw1, the high white display voltage Vw is referred to as a second white display voltage Vw2, and the high whitening pulse voltage Vedw is referred to as a second whitening pulse voltage Vedw2. The whitening pulse time tw is constant.

Referring to FIG. 7, since steps S11 and S21 are the same as those in the first embodiment of FIG. 5, the description of them is omitted. When the display updating interval tin is shorter than the predetermined time period tth (step S21: Yes), all the pixels 11 are supplied with the first white display voltage Vw1 for the whitening pulse time interval tw in step S35 (a first whitening step).

When the display update interval tin is longer than or equal to the predetermined time period tth (step S21: No), all the pixels 11 are supplied with the second white display voltage Vw2 for the whitening pulse time tw in step S37 (a second whitening step). Since steps S41 to S61 are the same as those in the first embodiment of FIG. 5, the description of them is omitted.

FIG. 8 is a timing chart showing the updating operation of the display of the pixel 11. FIG. 8 has the same content as FIG. 6.

Referring to FIG. 8, the pixel Pmn is supplied with the first white display voltage Vw1 from time T0 for the whitening pulse time tw, whereby the ED device 17 of the pixel Pmn is supplied with the first whitening pulse voltage Vedw1. The pixel Pmn is made to display the white display W from the black display B by way of the gray display Gin the whitening response time trw1, which is shorter than the whitening pulse time tw. In this state, the pixel P11 has a reflectance R which is the reflectance Rw of white.

After the elapse of the predetermined wait time tk, the pixel Pmn is supplied with the black display voltage Vb for the blackening pulse time tb, whereby the ED device 17 of the pixel Pmn is supplied with the blackening pulse voltage Vedb. The pixel Pmn is made to display the black display B from the white display W by way of the gray display G in the blackening response time trb, which is shorter than the blackening pulse time tb. In this state, the pixel Pmn has a reflectance R which is the reflectance Rb of the black display. However, the predetermined wait time tk may be omitted. By the above process, the updating operation of the display of the pixel Pmn to the black display B by the updating operation Cr1 is completed.

After the elapse of the display updating interval tin1, the display of the pixel Pmn is updated to the black display by the updating step Cr2. In this case, because the display updating interval tin1 is shorter than the predetermined time period tth, the operation of step S35 (a first whitening step) of FIG. 7 is performed, under the condition: the voltage set as the whitening pulse voltage Vedw=the first whitening pulse voltage Vedw1.

The pixel Pmn is supplied with the first white display voltage Vw1 from time T1 for the whitening pulse time tw, whereby the ED device 17 of the pixel Pmn is supplied with the first whitening pulse voltage Vedw1. The pixel Pmn is made to display the white display W from the black display B by way of the gray display G in the whitening response time trw1, which is shorter than the whitening pulse time tw. In this state, the pixel Pmn has a reflectance R which is the reflectance Rb of the black display.

After the elapse of the predetermined wait time tk, the pixel Pmn is supplied with the black display voltage Vb for the blackening pulse time tb, whereby the ED device 17 of the pixel Pmn is supplied with the blackening pulse voltage Vedb. The pixel Pmn is made to display the black display B from the white display W by way of the gray display G in the blackening response time trb, which is shorter than the blackening pulse time tb. In this state, the pixel Pmn has a reflectance R which is the reflectance Rb of the black display. However, the predetermined wait time tk may be omitted. By the above process, the updating operation is completed in which the pixel Pmn is updated to the black display 13 by the updating operation Cr2 after the elapse of the display updating interval tin1.

Next, after the elapse of the display updating interval tin2, the display of the pixel Pmn is updated to the black display by the updating operation Cr3. In this case, because the display updating interval tin2 is longer than the predetermined time period tth, the operation of step S37 (a second whitening step) of FIG. 7 is performed, under the condition: the whitening pulse voltage Vedw=the second whitening pulse voltage Vedw2.

The pixel Pmn is supplied with the second white display voltage Vw2 from time T2 for the whitening pulse time tw, whereby the ED device 17 of the pixel Pmn is supplied with the second whitening pulse voltage Vedw2. The pixel Pmn is made to display the white display W from the black display B by way of the gray display G in the whitening response time trw1, which is shorter than the second whitening pulse time tw. In this state, the pixel Pmn has a reflectance R which is the reflectance Rw of white.

After the elapse of the predetermined wait time tk, the pixel Pmn is supplied with the black display voltage Vb for the blackening pulse time tb, whereby the ED device 17 of the pixel Pmn is supplied with the blackening pulse voltage Vedb. The pixel Pmn is made to display the black display B from the white display W by way of the gray display G in the blackening response time trb, which is shorter than the blackening pulse time tb. In this state, the pixel Pmn has a reflectance R which is the reflectance Rb of the black display. However, the predetermined wait time tk may be omitted. By the above process, the updating operation is completed in which the pixel Pmn is updated to the black display B by the updating operation Cr3 after the elapse of the display updating interval tint.

As described above, according to the second embodiment, a method for driving an ED device and an information display apparatus are provided, by which method and in which apparatus the ED device is sufficiently whitened, and the Ed device has excellent durability. The method comprises: a step of depositing metal by applying a blackening pulse to a pixel of the ED device; and a step of dissolving the deposited metal by applying a whitening pulse, wherein in the case of updating the display of the ED device, when the elapse of time (a display updating interval) since the blackening step before the update of display is shorter than the predetermined time, the whitening pulse voltage is set low (a first whitening step), and when the display updating interval is longer than or equal to the predetermined time, the whitening pulse voltage is set high (a second whitening step).

In addition, the first embodiment and the second embodiment may be combined, and when the elapsed time (the display updating interval) since the metal was deposited in the blackening step before the update of the display is shorter than the predetermined time, the whitening pulse time may be set short and the whitening pulse voltage may be set low (the first whitening step), and when the display updating interval is longer than or equal to the predetermined time, the whitening pulse time may be set long and the whitening pulse voltage may be set high (the second whitening step).

In this case, when the display updating interval is shorter than the predetermined time interval, the whitening pulse time can be set short; thus a method for driven the ED device and an information display apparatus can be provided in which the time period needed to update the display can be shortened.

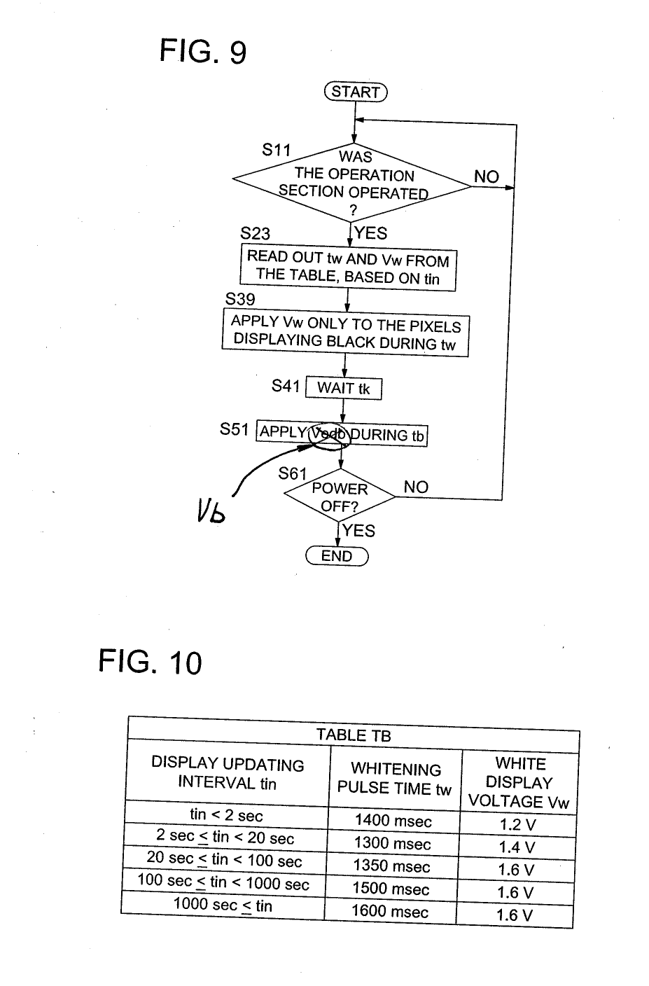

Next, a third embodiment of the present invention is described with reference to FIGS. 9 to 11. In the third embodiment, a table TB having the whitening pulse times tw and the white display voltages Vw corresponding to the display updating intervals tin is prepared in advance, and the whitening pulse is applied to the pixel 11 according to the table TB.

In addition, in the first and second embodiment, description was made on a so called total reset method in which when the update of display is performed, all the pixels 11 is initialized to the white display, and only the needed pixels 11 are then set to the black display. However, in the second embodiment, there is described a so called negative reset method in which only the pixels 11 in which silver has been deposited to display black by the blackening step proceeding the updating of display are initialized to display white, and only the required pixels 11 are then made to display black.

FIG. 9 is a flow chart showing the operation of updating the display of the pixel 11 of the third embodiment.

Referring to FIG. 5, in step S11, it is checked whether any of the forward operation section 51 and the backward operation section 52 of the operation section 5 was operated or not. If it was not operated (step S11: No), the process waits in step S11 until the operation is done.

If the operation is done (step S11: Yes), the pair of the whitening pulse time tw and the white display voltage Vw corresponding to the display updating interval tin is read out from the table TB in step S23. FIG. 10 shows an example of the table TB.

Referring to FIG. 10, in the table TB, there are prepared pairs of the whitening pulse times tw and the white display voltages Vw corresponding to the display updating intervals tin. For example, when the display updating interval tin <2 s, the whitening pulse time tw=1,400 ms, and the white display voltage Vw=12 V. If the display updating interval tin ≧1000 s, the whitening pulse time interval tw=1,600 ms, and the white display voltage Vw=1.6 V. In the third embodiment, the whitening pulse time interval tw and the white display voltage Vw are controlled depending on the display updating interval according to the basis of the table TB.

Referring back to FIG. 9, in step S39 (a whitening step), only the pixels 11 which were made to display black in the blackening step before the update of display are supplied with the white display voltage Vw read out in step S23 for the whitening pulse time tw read out in step S23. The pixels 11 which display white before the update of display are not supplied with the whitening pulse. Since steps S41 to S61 are the same as those in FIG. 5, the description of them is omitted.

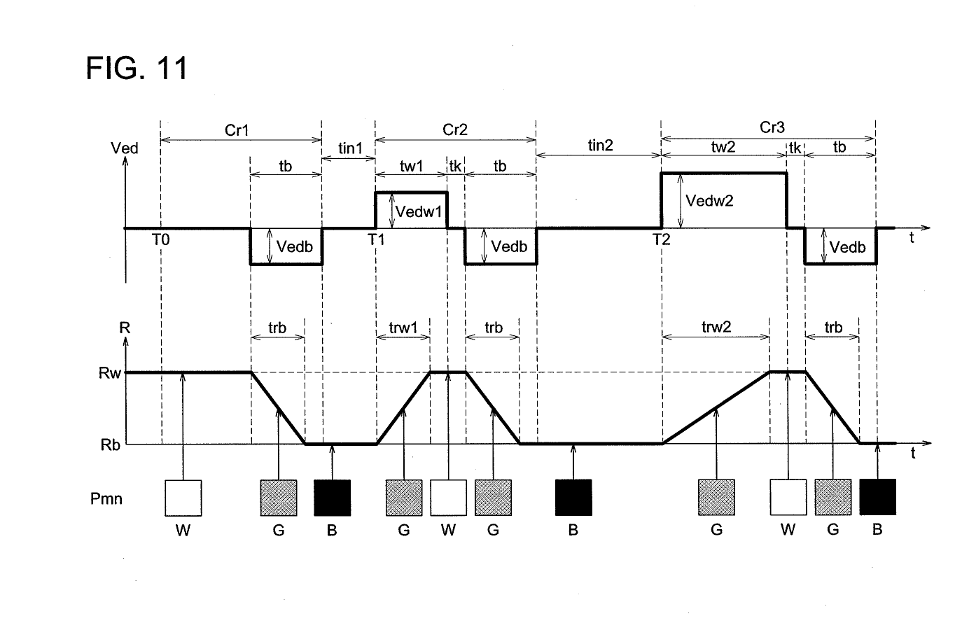

FIG. 11 is a timing chart showing the updating operation of the display of the pixel 11 of the third embodiment. The content shown in FIG. 11 is the same as that in FIGS. 6 and 8.

FIG. 11 shows an example in which the pixel Pmn is updated from the white display to the black display by the updating operation Cr1, and after the display updating interval tin 1, the pixel Pmn is updated to the black display by the updating operation Cr2, further after the display interval tin2, the pixel Pmn is updated again to the black display by the updating operation Cr3. In the table TB of FIG. 10, assuming that the whitening pulse time tw and the white display voltage Vw corresponding to the display updating interval tin1 are tw1 and Vw1 respectively. Assuming that the whitening pulse time tw and the white display voltage Vw corresponding to the display updating interval tin2 are tw2 and Vw2, respectively.

Referring to FIG. 11, assuming that the pixel Pam initially displays white. Since the third embodiment employs a negative reset method, the pixel Pmn is not supplied with the whitening pulse Pw in the updating operation Cr1. The other pixels 11 displaying black are supplied with the whitening pulse pw in the front half of the updating operation Cr1.

In the last half of the updating operation Cr1, the pixel Pmn is supplied with the black display voltage Vb for the blackening pulse period tb, whereby the ED device 17 of the pixel Pmn is supplied with the blackening pulse voltage Vedb. The pixel Pmn is made to display the black display B from the white display W by way of the gray display G in the blackening response time trb, which is shorter than the blackening pulse time tb. In this state, the pixel Pmn has a reflectance R which is the reflectance Rb of the black display. In the above process, the updating operation of the pixel Pmn to the black display by the updating operation Cr1 is completed.

Next, after the elapse of the short display updating interval tint, the pixel Pmn is updated to the black display by the updating operation Cr2. Since the pixel Pmn is made to display black by the previous update of display, the pixel Pmn is supplied with the whitening pulse Pw in this update of display.

The pixel Pam is supplied with the white display voltage Vw1 read out from the table TB shown in FIG. 10 for the whitening pulse time tw1 read out from the table TB, whereby the ED device 17 of the pixel Pmn is supplied with the whitening pulse voltage Vedw1. The pixel Pmn is made to display the white display W from the black display B by way of the gray display G in the whitening response time trw1, which is shorter than the whitening pulse time tw1. In this state, the pixel Pmn has a reflectance R which is the reflectance Rw of white.

After the elapse of the predetermined wait time tk, the pixel Pmn is supplied with the black display voltage Vb for the blackening pulse time tb, whereby the ED device 17 of the pixel Pmn is supplied with the blackening pulse voltage Vedb. The pixel Pmn is made to display the black display B from the white display W by way of the gray display G in the blackening response time trb, which is shorter than the blackening pulse time tb. In this state, the pixel Pmn has a reflectance R which is the reflectance Rb of the black display. However, the predetermined wait time tk may be omitted. By the above process, the updating operation is completed in which the pixel Pmn is updated to the black display B by the updating operation Cr2 after the elapse of the display updating interval tin1.

Next, after the elapse of the display updating interval tin2, the display of the pixel Pmn is updated to the black display by the updating operation Cr3. The pixel Pmn is supplied with the white display voltage Vw2 read out from the table TB shown in FIG. 10 from timing T2 for the whitening pulse time tw1, whereby the ED device 17 of the pixel Pmn is supplied with the whitening pulse voltage Vedw2. The pixel Pmn is made to display the white display W from the black display B by way of the gray display G in the whitening response time trw2, which is shorter than the second whitening pulse time tw2. In this state, the pixel Pmn has a reflectance R which is the reflectance Rw of white.

After the elapse of the predetermined wait time tk, the pixel Pmn is supplied with the black display voltage Vb for the blackening pulse time tb, whereby the ED device 17 of the pixel Pmn is supplied with the blackening pulse voltage Vedb. The pixel Pmn is made to display the black display B from the white display W by way of the gray display Gin the blackening response time trb, which is shorter than the blackening pulse time tb. In this state, the pixel Pmn has a reflectance R which is the reflectance Rb of the black display. However, the predetermined wait time tk may be omitted. By the above process, the updating operation is completed in which the pixel Pmn is updated to the black display B by the updating operation Cr3 after the elapse of the display updating interval tin2.

As described above, according to the third embodiment, a method for driving the ED device and an information display apparatus are provided, by which method and in which apparatus the ED device is sufficiently whitened, and the ED device has excellent durability. The method comprised: a blackening step for applying a blackening pulse for depositing metal in an ED device; and a whitening step for applying a whitening pulse for resolving the metal deposited in the blackening step, wherein pairs of whitening pulse times and white display voltages corresponding to display updating intervals are prepared as a table, and in the whitening step, the whitening pulse is applied according to the pair of the whitening pulse time and the white display voltage prepared in the table on the basis of the display updating interval.

In addition, in the case that the display updating interval is short, the whitening pulse time can be set short, thereby providing a method for driving the ED device and an information display apparatus in which the time period for updating the display can be short.

In addition, since by employing a negative reset method, the pixels 11 not showing black, that is, the pixels 11 in which no silver is deposited are not supplied with the whitening pulse for resolving the silver, a method for driving the ED device and an information display apparatus which have more excellent durability are provided.

Further, in the third embodiment, the pairs of the whitening pulse time intervals and the white display voltages corresponding to the display updating intervals are prepared in advance, however the display updating interval tin, the whitening pulse time tw, and the whitening pulse voltage Vedw may be correlated by a predetermined mathematical expression, and the whitening pulse time tw and the whitening pulse voltage Vedw may be controlled according to the predetermined mathematical expression.

As described above, according to the present invention, a method for driving the ED device and an information display apparatus are provided, by which method and in which apparatus the ED device is sufficiently whitened, the ED device has more excellent durability, and the time needed to update the display is shortened. The method comprises: a blackening step for applying a blackening pulse for depositing metal in an ED device; and a whitening step for applying a whitening pulse for resolving the metal deposited in the blackening step, wherein in the whitening step, any one of or both of the application voltage and the application time period of the whitening pulse is changed depending on the elapse of time since metal was deposited in the blackening step.

It should be noted that the detailed configurations and the detailed operations of the configurations constituting the method for driving an ED device and the information display apparatus according to the present invention can be modified as required without departing from the spirit of the present invention.

### EXAMPLES

Detailed examples of the embodiment according to the present invention are described below without limiting the present invention to the examples.

First, the terms used in the Examples are described.

(ED Device Material)

In the Examples, the silver or the compound including silver in the chemical structure is a collective term of the compounds including silver oxide, silver sulfide, metallic silver, silver colloid particles, silver halide, silver complex compound, and silver ions, and there is no restriction on the state of phases such as the solid state, the solubilization state with respect to liquid, or on the states of charge such as the neutrality, the anion, and the cation.

The electrolyte liquid of the Examples preferably includes silver ions with the concentration of 0.2 mol/kg≦[Ag]≦2.0 mol/kg. If the silver ion concentration is lower than 0.2 mol/kg, the silver solution is so thin that the driving speed is lowered, instead if the silver ion concentration is higher than 2 mol/kg, the solubility is bad and deposition tends to occur during low temperature storage, which is disadvantageous.

(Electrolyte)

The electrolyte is generally material which is soluble in solvent such as water and whose solution exhibits ionic conductivity, however in the description of the Examples, the electrolyte can include other non-electrolyte component.

The electrolyte disposed between opposite electrodes of the Examples selectively includes, as required, organic solvent, ionic liquid, oxidation-reduction active material, supporting electrolyte, complexing agent, white scattering agent, or high molecular binder.

(Low Viscosity Electrolyte, Gel-Like Electrolyte)

The electrolyte is usually classified into the liquid electrolyte (hereinafter, referred to as “electrolyte liquid”) or the polymer electrolyte. The polymer electrolyte is further classified into the solid electrolyte substantially composed of solid compound, and the gel-like electrolyte made up of polymer compound and electrolyte liquid. With respect to fluidity, the solid electrolyte has no fluidity, and the gel-like electrolyte has an intermediate solidity between that of the electrolyte liquid and that of the solid electrolyte.

The gel-like electrolyte of the Examples is an electrolyte liquid which has high viscosity and fluidity at the room temperature, and is gel-like electrolyte or high viscosity electrolyte liquid which have a viscosity at 25° C. of 100 mPa·s or higher and 1,000 mPa·s or lower. Further, the gel-like electrolyte of the Examples does not have to have a property of temperature-sensitive sol-gel transition.

In addition, the low viscosity electrolyte liquid of the Examples has a viscosity of 0.1 mPa·s or higher and lower than 100 mPa·s, and preferably includes high molecular binder of less than 10% with respect to the solvent of the electrolyte.

(Composition of ED Device 17 for Evaluation)

In the first to third embodiment, the description is made assuming that the pixel 11 is an active matrix device having two TFTs and one ED device. However, in the first to fourth Example, in order to confirm the advantage without the influence of the TFT, simple matrix ED devices are used whose pixels are formed at the intersections of the common electrodes 113 and the pixel electrodes 111 which are arranged in matrix.

### Example 1

The ED devices 17 for evaluation of Example 1 were made as follows.

(Preparation of Electrolyte Liquid 123)

Sodium iodide 90 mg and silver iodide 75 mg were added to 2.5 g of dimethylsulfoxide (hereinafter, referred to as “DMSO”) and entirely resolved, and 150 mg of polyvinylpyrrolidone with an average molecular weight of 15,000 was then added, and the mixture was agitated for one hour while being heated to 120° C., whereby a solution was obtained. Further into the solution, 0.25 g of polyethyleneglycol (hereinafter, referred to as “PEG”) with an average molecular weight of 100,000 and 1.26 g of titanium oxide powder were mixed, whereby gel-like white electrolyte liquid 123 was obtained.

(Fabrication of Common Substrate 103)

A glass substrate was used as the common substrate 103, and a transparent conductive film ITO with 150 nm thickness was formed on the common substrate 103 by a sputtering method, and a patterning process was performed by using a well known photolithography method, whereby the 50 stripe common electrodes 113 with 180 μm width and 200 μm pitch are obtained.

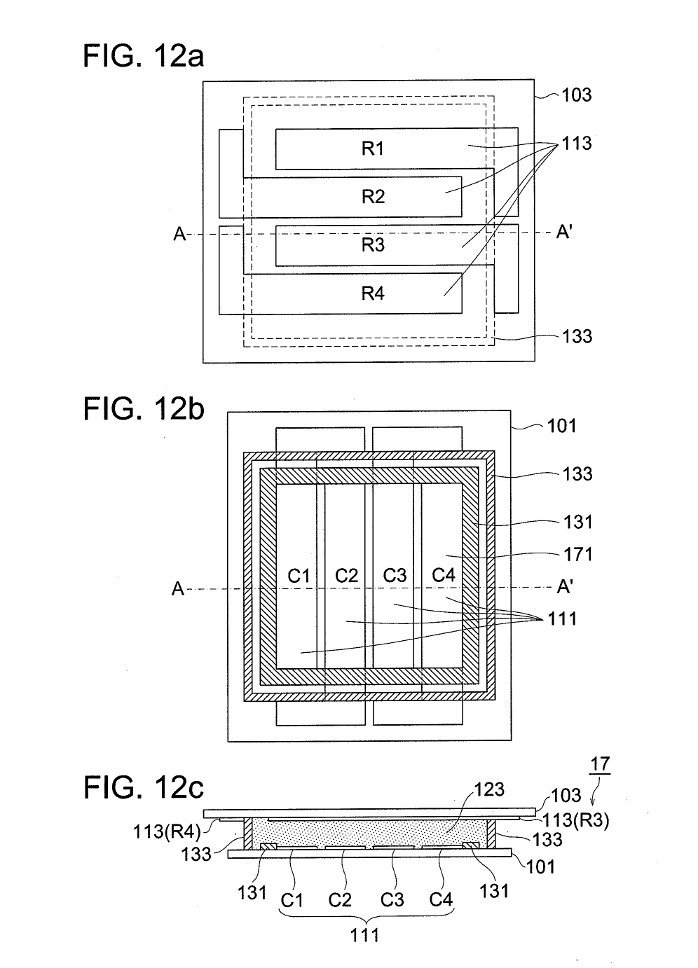

FIG. 12a shows the shapes of the ED device 17 for evaluation, the common substrate 103, and the common electrodes 13 of Example 1. However, the 50 common electrodes 113 were formed on the common substrate 103, but FIG. 12a shows only four of the common electrodes 113 for the sake of simplicity. The four common electrodes 113 are each referred to as R1, R2, R3, and R4 from the top of the drawing. The portion indicated by a broken line in the drawing is sealed with the seal pattern 133 described later.

(Fabrication of Drive Substrate 101)

A glass substrate was used as the drive substrate 101, and a silver-palladium electrode (including 2% by mass of Pd) as a metal electrode with 200 nm thickness was formed on the drive substrate 101 by a sputtering method, and a patterning process was performed by using a well known photolithography method, whereby the 50 stripe pixel electrodes 111 with 180 μm width and 200 μm pitch are obtained.

(Fabrication of Opening 171)

On the pixel electrodes 111 of the drive substrate 101, a coated photosensitive isolation film with 2 mm thickness was formed with the PC403 made by JSR Corporation with a spin-coater by 1,000 rpm. The UV patterning exposure was performed with an exposure of 200 mJ/cm². Development is performed with an aqueous solution of 38% of tetramethylammonium hydroxide (TMAH2) for 1 minute. Baking was performed at 220° C. for 1 hour. By the above process, the isolation layer 131 was obtained. The isolation layer 131 defines the size of the opening (display portion) 171 to be 10 mm×10 mm.

(Fabrication of Seal Pattern 133)

Epoxy resin was screen printed to form the seal pattern 133 such that the seal pattern surrounded the outer side of the isolation layer 131 of the drive substrate 101 in which the opening 171 was formed. FIG. 12b shows the shapes of the drive substrate 101, the pixel electrodes 111, the isolation layer 131, the opening 171, and the seal pattern 133. However, the 50 pixel electrodes 111 were formed on the drive substrate 101, but FIG. 12b shows only four of the pixel electrodes 111 for the sake of simplicity. The four pixel electrodes 111 are each referred to as C1, C2, C3, and C4 from the left side of the drawing.

(Fabrication of ED Device 17 for Evaluation)

The drive substrate 101 and the common substrate 103 were stacked and glued with the seal pattern 133 such that the pixel electrodes 111 and the common electrodes 113 were opposed with the stripe directions of the electrodes being perpendicular to each other. In the space between the glued drive substrate 101 and the common substrate 103, the gel-like white electrolyte liquid 123 of Example 1 was injected by a vacuum injection method, and the injection port was sealed with acrylic UV-curable resin, whereby the ED device 17 for evaluation of Example 1 was fabricated.

FIG. 12c shows the cross section of the ED device 171 for evaluation of Example 1. FIG. 12c shows the cross section along the lines A-A′ of FIGS. 12a and 12b. The electrolyte liquid 123 is encapsulated between the drive substrate 101 and the common substrate 103 which are glued with the seal pattern 133, and the pixel electrodes 111 and the common electrodes 113 are opposed having the electrolyte liquid 123 therebetween with the stripe directions of the electrodes being perpendicular to each other. The size of the opening (display portion) 171 of the pixel electrodes 111 are determined by the isolation layer 131.

(Device Characteristic Evaluation of ED device 17 for Evaluation)

By using the ED device 17 for evaluation of Example 1 obtained by the above process, an examination was made on the correlation between the display updating interval tin and the condition for whitening the pixel 11 (the whitening response time trw and the whitening pulse voltage Vedw). In Example 1, all the pixels 11 of the fabricated ED device 17 for evaluation of Example 1 were parallel connected, and all the pixels 11 were simultaneously supplied with the whitening pulse Pw.

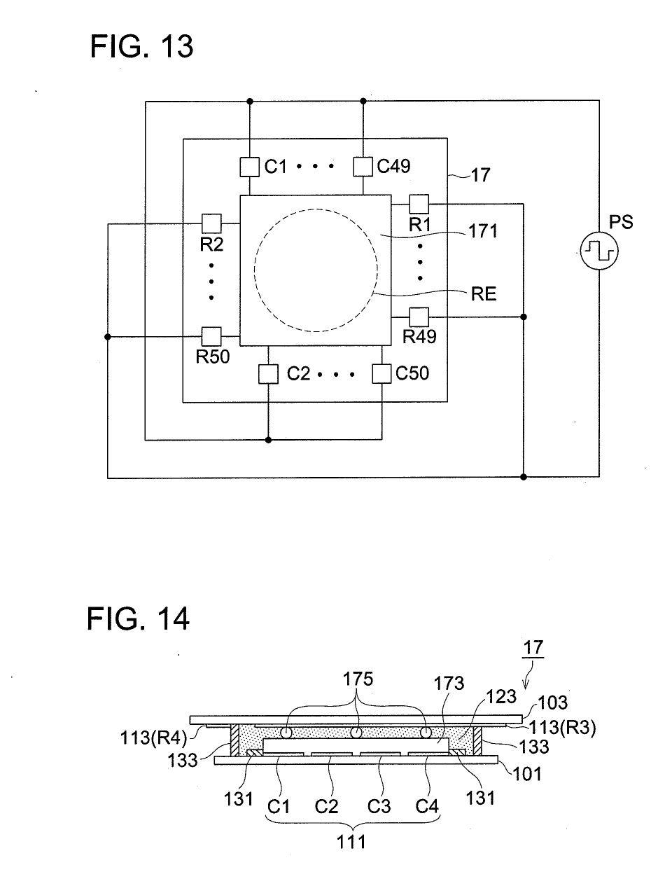

FIG. 13 shows how to connect for the evaluation of Example 1. The opening (display portion) 171 is formed at the center of the ED device 17 for evaluation, and the common electrodes R1-R50 and the pixel electrodes C1-C50 are provided around the opening. The common electrodes R1-R50 are all connected to one line, which is connected to one terminal of the pulse power source PS. The pixel electrodes C1-C50 are also all connected to one line, which line is connected the other terminal of the pulse power source.

The updating operation was performed in which for every display updating interval tin, the whitening pulse Pw was applied, and immediately thereafter, the blackening pulse Pb was applied as shown in FIG. 4 from the pulse power source PS under the following conditions. The conditions of the display updating interval tin and the blackening pulse Pb were as follows:

Display updating interval=six levels of 1 s, 10 s, 60 s, 300 s, 1,800 s, and 3,600 s;

Blackening pulse time tb=800 ms.

The blackening pulse voltage Vedb=−1.5 V.

The application time of the whitening pulse Pw was changed for every whitening pulse voltage Vedw, and the whitening response time trw needed to fully whiten the opening (display portion) 171 was measured. The whitening pulse voltages Vedw were as follows: the whitening pulse voltage Vedw=the six levels of 0.4 V, 0.6 V, 0.8 V, 1.0 V, 1.2 V, 1.4 V, 1.6 V, and 1.8 V.

The whitening was judged by the reflectance of the reflectance measuring area RE with a diameter of 8 mm located at the center of the opening (display portion) 171 (10 mm×10 mm) and by the visual observation. The results of the evaluation are shown in Table 1.

TABLE 1

| | Whitening Pulse | |
|---|---|---|
| Display Updating | Voltage Vedw | Whitening Response Time |
| Interval tin (s) | (V) | trw (ms) |
| 1 | 0.4 | Not perfectly whitened |
| 1 | 0.6 | 12,000 |
| 1 | 0.8 | 6,000 |
| 1 | 1.0 | 2,150 |
| 1 | 1.2 | 1,100 |
| 1 | 1.4 | 730 |
| 1 | 1.6 | 530 |
| 1 | 1.8 | Bubbles generated by 100 repeats |
| 10 | 0.4 | Not perfectly whitened |
| 10 | 0.6 | Not perfectly whitened |
| 10 | 0.8 | 8,900 |
| 10 | 1.0 | 3,100 |
| 10 | 1.2 | 1,500 |
| 10 | 1.4 | 990 |
| 10 | 1.6 | 810 |
| 10 | 1.8 | Bubbles generated by 100 repeats |
| 60 | 0.4 | Not perfectly whitened |
| 60 | 0.6 | Not perfectly whitened |
| 60 | 0.8 | 12,000 |
| 60 | 1.0 | 3,900 |
| 60 | 1.2 | 2,100 |
| 60 | 1.4 | 1,300 |
| 60 | 1.6 | 1,050 |
| 60 | 1.8 | Bubbles generated by 100 repeats |
| 300 | 0.4 | Not perfectly whitened |
| 300 | 0.6 | Not perfectly whitened |
| 300 | 0.8 | 14,000 |
| 300 | 1.0 | 4,700 |
| 300 | 1.2 | 2,400 |
| 300 | 1.4 | 1,560 |
| 300 | 1.6 | 1,160 |
| 300 | 1.8 | Bubbles generated by 100 repeats |
| 1,800 | 0.4 | Not perfectly whitened |
| 1,800 | 0.6 | Not perfectly whitened |
| 1,800 | 0.8 | 15,000 |
| 1,800 | 1.0 | 5,100 |
| 1,800 | 1.2 | 2,600 |
| 1,800 | 1.4 | 1,710 |
| 1,800 | 1.6 | 1,290 |
| 1,800 | 1.8 | Bubbles generated by 100 repeats |
| 3,600 | 0.4 | Not perfectly whitened |
| 3,600 | 0.6 | Not perfectly whitened |
| 3,600 | 0.8 | 15,000 |
| 3,600 | 1.0 | 5,110 |
| 3,600 | 1.2 | 2,620 |
| 3,600 | 1.4 | 1,750 |
| 3,600 | 1.6 | 1,300 |
| 3,600 | 1.8 | Bubbles generated by 100 repeats |

*The blackening pulse time tb = 800 ms, the blackening pulse voltage Vedb = −1.5 V.

With reference to the results of Table 1, for example, in the case of the whitening pulse voltage Vedw=1.2 V, the whitening response times trw for the different display updating intervals tin were as follows:

tin=1 s: trw=1,100 ms;

tin=10 s: trw=1,500 ms;

tin=60 s: trw=2,100 ms;

tin=300 s: trw=2,400 ms;

tin=1,800 s: trw=2,600 ms;

tin=3,000 s: trw=2,620 ms.

### Verification of Advantages of Example

With reference to the results of Table 1, verification was made on the preferable application conditions of the whitening pulse of Example 1 and Comparative Examples by using the ED device 17 for evaluation. The results are shown in Table 2.

TABLE 2

| | | | | | | Contrast | |
|---|---|---|---|---|---|---|---|
| | | Whitening | Blackening | Blackening | | After | After |
| | Whitening Pulse | Pulse Voltage | Pulse Time | Pulse Voltage | Display Updating | first | 1000th |
| | Time tw (ms) | Vedw (V) | tb (ms) | Vedb (V) | Interval tin (s) | drive | drive |
| Example 1-1 | Whitening reaction | 1.2 | 800 | −1.5 | 1, 10, 60, 300, 1,800, | 10.3 | 10.5 |
| | time trw of | | | | 3,600 at random | | |
| | Table 1 +300 ms | | | | | | |
| Comparative | 2,920 | 1.2 | 800 | −1.5 | 1 | 10.2 | 3.3 |
| Example 1 | | | | | | | |
| Comparative | 2,200 | 1.2 | 800 | −1.5 | 1, 10, 60, 300, 1,800, | 10.2 | Bubble |
| Example 2 | | | | | 3,600 at random | | generated |
| Example 1-2 | Whitening reaction | 1.6 | 800 | −1.5 | 1, 10, 60, 300, 1,800, | 9.9 | 10.2 |
| | time trw of | | | | 3,600 at random | | |
| | Table 1 +300 ms | | | | | | |
| Comparative | 1,580 | 1.6 | 800 | −1.5 | 1 | 10.5 | 2.1 |
| Example 3 | | | | | | | |
| Comparative | 1,150 | 1.6 | 800 | −1.5 | 1, 10, 60, 300, 1,800, | 10.3 | Bubble |
| Example 4 | | | | | 3,600 at random | | generated |
| Example 1-3 | 1,600 | 1.18 | 800 | −1.5 | 1 | 10.3 | 10.5 |
| Right conditions | 1,600 | 1.3 | 800 | −1.5 | 10 | | |
| were randomly | 1,600 | 1.4 | 800 | −1.5 | 60 | | |
| employed. | 1,600 | 1.5 | 800 | −1.5 | 300 | | |
| | 1,600 | 1.6 | 800 | −1.5 | 1,800 | | |
| | 1,600 | 1.6 | 800 | −1.5 | 3,600 | | |
| Comparative | 1,600 | 1.6 | 800 | −1.5 | 1 | 10.5 | 1.9 |
| Example 5 | | | | | | | |

### Example 1-1

The whitening pulse voltage Vedw was fixed to 1.2 V. The display updating interval tin was randomly set to any of the six values: 1 s, 10 s, 60 s, 300 s, 1,800 s, and 3,600 s. The whitening pulse time was set to the whitening response time+300 ms, which whitening response time was obtained from Table 1 in correspondence to the different display updating intervals tin and was for the whitening pulse voltage Vedw of 1.2 V. Under the above conditions, the drive was performed 1,000 times, and the contrast of the opening portion (display portion) 171 was measured after the first drive and the 1,000th drive. The result was that the contrast was 10.3 after the first drive and 10.5 after the 1,000th drive, and there was no difference.

The contrast here is the ratio of the Y value (%), for the white display, measured inside the reflection measurement area RE with the diameter of 8 mm at the center of the opening (display portion) 171 (10 mm×10 mm) with respect to the Y value (%) for the black display.

Since there is a relation: the contrast the reflectance Rw, the contrast is expressed as follows: the contrast=the reflectance Rw for the white display/reflectance Rh for the black display.

This expression is also applied to the following Examples.

The measurement of reflectance was conducted from the side of the common substrate 103.

### Comparable Example 1

With respect to Example 1-1, the display updating interval tin was fixed to 1 s, the whitening pulse time tw was fixed to 2,920 ms, and the other conditions were the same. Under the above conditions, the drive was performed 1,000 times, and the contrast of the opening portion (display portion) 171 was measured after the first drive and the 1,000th drive. The result was that the contrast was 10.2 after the first drive, and this value was not much different from the result of Example 1-1. However, the contrast after the 1,000th drive was 3.3, and the display performance was apparently degraded.

### Comparable Example 2

With respect to Example 1-1, the whitening pulse time tw was fixed to 2,200 ms, and the other conditions were the same. Under the above conditions, the drive was performed 1,000 times, and the contrast of the opening portion (display portion) 171 was measured after the first drive and the 1,000th drive. The result was that the contrast was 10.2 after the first drive, and this value was not much different from the result of Example 1-1. However, after the 1,000th drive, bubbles were generated and the device was broken.

### Example 1-2

With respect to Example 1-1, the whitening pulse voltage Vedw was changed to 1.6 V, and the other conditions were the same. Under the above conditions, the drive was performed 1,000 times, and the contrast of the opening portion (display portion) 171 was measured after the first drive and the 1,000th drive. The result was that the contrast was 9.9 after the first drive, and the contrast after 1,000th drive was 10.2, which was not much different from the result in Example 1-1.

### Comparable Example 3

With respect to Example 1-2, the display updating interval tin was fixed to 1 s, the whitening pulse time tw was fixed to 1,580 ms, and the other conditions were the same. Under the above conditions, the drive was performed 1,000 times, and the contrast of the opening portion (display portion) 171 was measured after the first drive and the 1,000th drive. The result was that the contrast was 10.5 after the first drive, and this value was not much different from the result of Example 1-2. However, the contrast after the 1,000th drive was 2.1, and the display performance was apparently degraded.

### Comparable Example 4

With respect to Example 1-2, the whitening pulse time tw was fixed to 1,150 ms, and the other conditions were the same. Under the above conditions, the drive was performed 1,000 times, and the contrast of the opening portion (display portion) 171 was measured after the first drive and the 1,000th drive. The result was that the contrast was 10.3 after the first drive, and this value was not much different from the result of Example 1-2. However, after the 1,000th drive, bubbles were generated and the device was broken.

### Example 1-3

The whitening pulse time tw fixed to 1,600 ms. The display updating interval tin was randomly set to any of the six values: 1 s, 10 s, 60 s, 300 s, 1,800 s, and 3,600 s. The whitening pulse voltage Vedw was set to the whitening pulse voltage Vedw, which whitening pulse voltage Vedw was obtained from Table 1 in correspondence to the display updating intervals tin, and was capable of whitening with the whitening response time trw of 1,300 ms. Under the above conditions, the drive was performed 1,000 times, and the contrast of the opening portion (display portion) 171 was measured after the first drive and the 1,000th drive. The result was that the contrast was 10.3 after the first drive and 10.5 after the 1,000th drive, and they were not much different from the results of Example 1-1.

### Comparable Example 5

With respect to Example 1-3, the display updating interval tin was fixed to 1 s, the whitening pulse voltage Vedw was fixed 1.6 V, and the other conditions were the same. Under the above conditions, the drive was performed 1,000 times, and the contrast of the opening portion (display portion) 171 was measured after the first drive and the 1,000th drive. The result was that the contrast was 10.2 after the first drive, and this value was not much different from the result of Example 1-3. However, the contrast after the 1,000th drive was 1.9, and the display performance was apparently degraded.

From the above results, it was confirmed that a method for driving an ED device which has excellent durability and in which the pixel ofdie ED device is sufficiently whitened can be provided by changing one of or both of the whitening pulse time tw and the whitening pulse voltage Eedw, depending on the display updating interval tin.

### Example 2

By the following process, the ED devices 17 for evaluation of Example 2 were fabricated.

(Preparation of Electrolyte Liquid 123)

Lithium bromide 90 mg and silver iodide 75 mg were added to 1.25 g of DMSO and 1.25 g of Gamma-Butyrolactone (yBL), and were entirely resolved, and 225 mg of polyvinylpyrrolidone with an average molecular weight of 15,000 was then added, and the mixture was agitated for one hour while being heated to 120° C., whereby a solution was obtained. Further into the solution, 0.375 g of PEG with an average molecular weight of 100,000 and 1.89 g of titanium oxide powder were mixed, whereby gel-like white electrolyte liquid 123 was obtained. The ED device for evaluation of Example 2 is the same as that in Example 1 except the electrolyte liquid 123.

Since titanium oxide was increased with respect to the electrolyte liquid 123 of Example 1, the reflectance of the white display was increased by approximately 20%. However, since the PEG was increased to reduce the sedimentation of the titanium oxide, the viscosity of the electrolyte liquid 123 was increased, whereby the whitening response time trw was prolonged by approximately 10%.

(Device Characteristic Evaluation of ED Device 17 for Evaluation)

By using the ED device 17 for evaluation of Example 2 obtained by the above process, examination was made on the correlation between the display updating intervals tin and the conditions (the whitening response time trw and the whitening pulse voltage Vedw) needed to whiten the pixel 11. The evaluation method and the evaluation conditions were the same as those of Example 1 except the conditions of the blackening pulse Pb. The conditions of the blackening pulse were as follows:

the blackening pulse time tb=900 ms;

the blackening pulse voltage Vedb=−1.5 V.

The evaluation results are shown in Table 3.

TABLE 3

| | Whitening Pulse | |
|---|---|---|
| Display Updating | Voltage Vedw | Whitening Response Time |
| Interval tin (s) | (V) | trw (ms) |
| 1 | 0.4 | Not perfectly whitened |
| 1 | 0.6 | 13,400 |
| 1 | 0.8 | 6,500 |
| 1 | 1.0 | 2,300 |
| 1 | 1.2 | 1,200 |
| 1 | 1.4 | 800 |
| 1 | 1.6 | 550 |
| 1 | 1.8 | Bubbles generated by 100 repeats |
| 10 | 0.4 | Not perfectly whitened |
| 10 | 0.6 | Not perfectly whitened |
| 10 | 0.8 | 10,000 |
| 10 | 1.0 | 3,400 |
| 10 | 1.2 | 1,650 |
| 10 | 1.4 | 1,090 |
| 10 | 1.6 | 890 |
| 10 | 1.8 | Bubbles generated by 100 repeats |
| 60 | 0.4 | Not perfectly whitened |
| 60 | 0.6 | Not perfectly whitened |
| 60 | 0.8 | 13,000 |
| 60 | 1.0 | 4,300 |
| 60 | 1.2 | 2,300 |
| 60 | 1.4 | 1,400 |
| 60 | 1.6 | 1,100 |
| 60 | 1.8 | Bubbles generated by 100 repeats |
| 300 | 0.4 | Not perfectly whitened |
| 300 | 0.6 | Not perfectly whitened |
| 300 | 0.8 | 15,400 |
| 300 | 1.0 | 5,200 |
| 300 | 1.2 | 2,650 |
| 300 | 1.4 | 1,700 |
| 300 | 1.6 | 1,300 |
| 300 | 1.8 | Bubbles generated by 100 repeats |
| 1,800 | 0.4 | Not perfectly whitened |
| 1,800 | 0.6 | Not perfectly whitened |
| 1,800 | 0.8 | 16,500 |
| 1,800 | 1.0 | 5,600 |
| 1,800 | 1.2 | 2,900 |
| 1,800 | 1.4 | 1,900 |
| 1,800 | 1.6 | 1,400 |
| 1,800 | 1.8 | Bubbles generated by 100 repeats |
| 3,600 | 0.4 | Not perfectly whitened |
| 3,600 | 0.6 | Not perfectly whitened |
| 3,600 | 0.8 | 16,500 |
| 3,600 | 1.0 | 5,600 |
| 3,600 | 1.2 | 2,900 |
| 3,600 | 1.4 | 1,900 |
| 3,600 | 1.6 | 1,400 |
| 3,600 | 1.8 | Bubbles generated by 100 repeats |

*The blackening pulse time tb = 900 ms, the blackening pulse voltage Vedb = −1.5 V.

With reference to the results of Table 3, for example, in the case of the whitening pulse voltage Vedw=1.2 V, the whitening response times trw for the different display updating intervals tin were as follows:

tin=1 s: trw=1,200 ms;

tin=10 s: trw=1,650 ms;

tin=60 s: trw=2,650 ms;

tin=300 s: trw=4,000 ms;

tin=1,800 s: trw=2,900 ms; tin=3,000 s: trw=2,900 ms.

### Verification of Advantages of Example

With reference to the results of Table 3, verification was made on the preferable application conditions of the whitening pulse of Example 2 and Comparative Examples by using the ED device 17 for evaluation. The results are shown in Table 4.

TABLE 4

| | | | | | | Contrast | |
|---|---|---|---|---|---|---|---|
| | | Whitening | Blackening | Blackening | | After | After |
| | Whitening Pulse | Pulse Voltage | Pulse Time | Pulse Voltage | Display Updating | first | 1000th |
| | Time tw (ms) | Vedw (V) | tb (ms) | Vedb (V) | Interval tin (s) | drive | drive |
| Example 2 | Whitening reaction | 1.2 | 900 | −1.5 | 1, 10, 60, 300, 1,800, | 10.7 | 10.8 |
| | time trw of | | | | 3,600 at random | | |
| | Table 3 +300 ms | | | | | | |
| Comparative | 3,200 | 1.2 | 900 | −1.5 | 1 | 10.8 | 3.9 |
| Example 6 | | | | | | | |
| Comparative | 2,400 | 1.2 | 900 | −1.5 | 1, 10, 60, 300, 1,800, | 10.1 | Bubble |
| Example 7 | | | | | 3,600 at random | | generated |

### Example 2

The whitening pulse voltage Vedw was fixed to 1.2 V. The display updating interval tin was randomly set to any of the six values: 1 s, 10 s, 60 s, 300 s, 1,800 s, and 3,600 s. The whitening pulse time was set to the whitening response time+300 ms, which whitening response time was obtained from Table 3 in correspondence to the different display updating intervals tin and was for the whitening pulse voltage Vedw of 1.2 V. Under the above conditions, the drive was performed 1,000 times, and the contrast of the opening portion (display portion) 171 was measured after the first drive and the 1,000th drive. The result was that the contrast was 10.7 after the first drive and 10.8 after the 1,000th drive, and there was no difference. The contrast here is the ratio of the Y value (%) for the white display, measured inside the reflection measurement area RE with the diameter of 8 mm at the center of the opening (display portion) 171 (10 mm×10 mm) with respect to the Y value (%) for the black display.

### Comparable Example 6

With respect to Example 2, the display updating interval tin was fixed to 1 s, the whitening pulse time tw was fixed to 3,200 ms, and the other conditions were the same. Under the above conditions, the drive was performed 1,000 times, and the contrast of the opening portion (display portion) 171 was measured after the first drive and the 1,000th drive. The result was that the contrast was 10.8 after the first drive, and this value was not much different from the result of Example 2. However, the contrast after the 1,000th drive was 3.9, and the display performance was apparently degraded.

### Comparable Example 7

With respect to Example 2, the whitening pulse time tw was fixed to 2,400 ms, and the other conditions were the same. Under the above conditions, the chive was performed 1,000 times, and the contrast of the opening portion (display portion) 171 was measured after the first drive and the 1,000th drive. The result was that the contrast was 10.1 after the first drive, and this value was not much different from the result of Example 2. However, after the 1,000th chive, bubbles were generated and the device was broken.

From the above results, it was confirmed that a method for driving an ED device which has excellent durability and in which the ED device is sufficiently whitened can provided by changing the whitening pulse time tw, depending on the display updating interval tin.

### Example 3

By the following process, the ED devices 17 for evaluation of Example 3 were fabricated.

(Preparation of Electrolyte Liquid 123)

Sodium iodide 90 mg and silver iodide 75 mg were added to 2.5 g of DMSO and were entirely resolved, and 150 mg of polyvinylpyrrolidone with an average molecular weight of 15,000 was then added, and the mixture was agitated for one hour while being heated to 120° C. to resolve, whereby a transparent electrolyte liquid 123 was obtained.

(Fabrication of ED Device 17 for Evaluation)

After forming the opening 171 in a similar manner to Example 1, screen printing method was performed on the surface by using ink in which titanium dioxide particles were dispersed in aqueous solution of polyvinyl alcohol, and drying was performed at 80° C. to form a white diffusion layer 173. Spacer beads 175 (silica particles with the diameter of 25 mm) were sprinkled on the surface.

On the drive substrate 101 on which the white diffusion layer 173 was formed, a seal pattern was screen printed with epoxy resin. The drive substrate 101 and the common substrate 103 were opposed and glued with the seal pattern such that the pixel electrodes 111 and the common electrodes 113 are opposed with the stripe patterns of the electrodes are perpendicular to each other.

In the space between the glued drive substrate 101 and the common substrate 103, the transparent electrolyte liquid 123 of Example 3 was injected by a vacuum injection method, and the injection port was sealed with acrylic UV-curable resin, whereby the ED device 17 for evaluation of Example 3 was fabricated. The ED device 17 for evaluation of Example 3 is the same as the ED device for evaluation of Example 1 except the configuration described above. The cross section of the ED device for evaluation of Example 3 is shown in FIG. 14.

(Device Characteristic Evaluation of ED Device 17 for Evaluation)

By using the ED device 17 for evaluation of Example 3 obtained by the above process, an examination was made on the correlation between the display updating interval tin and the conditions (the whitening response time trw and the whitening pulse voltage Vedw) for whitening the pixel 11. The evaluation method and the evaluation conditions were the same as those of Example 1 except the conditions of the blackening pulse Pb. The conditions of the blackening pulse were as follows:

the blackening pulse time tb=1,600 ms;

the blackening pulse voltage Vedb=−1.5 V.

The evaluation results are shown in Table 5.

TABLE 5

| | Whitening Pulse | |
|---|---|---|
| Display Updating | Voltage Vedw | Whitening Response Time |
| Interval tin (s) | (V) | trw (ms) |
| 1 | 0.4 | Not perfectly whitened |
| 1 | 0.6 | 20,000 |
| 1 | 0.8 | 9,800 |
| 1 | 1.0 | 3,500 |
| 1 | 1.2 | 1,800 |
| 1 | 1.4 | 1,200 |
| 1 | 1.6 | 850 |
| 1 | 1.8 | Bubbles generated by 100 repeats |
| 10 | 0.4 | Not perfectly whitened |
| 10 | 0.6 | Not perfectly whitened |
| 10 | 0.8 | 15,000 |
| 10 | 1.0 | 5,500 |
| 10 | 1.2 | 2,450 |
| 10 | 1.4 | 1,600 |
| 10 | 1.6 | 1,300 |
| 10 | 1.8 | Bubbles generated by 100 repeats |
| 60 | 0.4 | Not perfectly whitened |
| 60 | 0.6 | Not perfectly whitened |
| 60 | 0.8 | 19,500 |
| 60 | 1.0 | 6,450 |
| 60 | 1.2 | 3,550 |
| 60 | 1.4 | 2,650 |
| 60 | 1.6 | 1,830 |
| 60 | 1.8 | Bubbles generated by 100 repeats |
| 300 | 0.4 | Not perfectly whitened |
| 300 | 0.6 | Not perfectly whitened |
| 300 | 0.8 | 24,000 |
| 300 | 1.0 | 8,100 |
| 300 | 1.2 | 4,000 |
| 300 | 1.4 | 2,550 |
| 300 | 1.6 | 1,950 |
| 300 | 1.8 | Bubbles generated by 100 repeats |
| 1,800 | 0.4 | Not perfectly whitened |
| 1,800 | 0.6 | Not perfectly whitened |
| 1,800 | 0.8 | 25,000 |
| 1,800 | 1.0 | 8,400 |
| 1,800 | 1.2 | 4,250 |
| 1,800 | 1.4 | 2,850 |
| 1,800 | 1.6 | 1,900 |
| 1,800 | 1.8 | Bubbles generated by 100 repeats |
| 3,600 | 0.4 | Not perfectly whitened |
| 3,600 | 0.6 | Not perfectly whitened |
| 3,600 | 0.8 | 25,100 |
| 3,600 | 1.0 | 8,450 |
| 3,600 | 1.2 | 4,300 |
| 3,600 | 1.4 | 2,800 |
| 3,600 | 1.6 | 2,000 |
| 3,600 | 1.8 | Bubbles generated by 100 repeats |

*The blackening pulse time tb = 1,600 ms, the blackening pulse voltage Vedb = −1.5 V.

With reference to the results of Table 5, for example, in the case of the whitening pulse voltage Vedw=1.2 V, the whitening response times trw for the different display updating intervals tin were as follows:

tin=1 s: trw=1,800 ms;

tin=10 s: trw=2,450 ms;

tin=60 s: trw=3,550 ms;

tin=300 s: trw=4,000 ms;

tin=1,800 s: trw=4,250 ms; tin=3,000 s: trw=4,300 ms.

### Verification of Advantages of Example

With reference to the results of Table 5, verification was made on the preferable application conditions of the whitening pulse of Example 3 and Comparative Examples by using the ED device 17 for evaluation. The results are shown in Table 6.

TABLE 6

| | | | | | | Contrast | |
|---|---|---|---|---|---|---|---|
| | | Whitening | Blackening | Blackening | | After | After |
| | Whitening Pulse | Pulse Voltage | Pulse Time | Pulse Voltage | Display Updating | first | 1000th |
| | Time tw (ms) | Vedw (V) | tb (ms) | Vedb (V) | Interval tin (s) | drive | drive |
| Example 3 | Whitening reaction | 1.2 | 1,600 | −1.5 | 1, 10, 60, 300, 1,800, | 10.6 | 10.5 |
| | time trw of | | | | 3,600 at random | | |
| | Table 5 +300 ms | | | | | | |
| Comparative | 4,600 | 1.2 | 1,600 | −1.5 | 1 | 10.8 | 2.2 |
| Example 8 | | | | | | | |
| Comparative | 3,650 | 1.2 | 1,600 | −1.5 | 1, 10, 60, 300, 1,800, | 10.5 | Bubble |
| Example 9 | | | | | 3,600 at random | | generated |

### Example 3

The whitening pulse voltage Vedw was fixed to 1.2 V. The display updating interval tin was randomly set to any of the six values: 1 s, 10 s, 60 s, 300 s, 1,800 s, and 3,600 s. The whitening pulse time was set to the whitening response time+300 ms, which whitening response time was obtained from Table 5 in correspondence to the different display updating intervals tin and was for the whitening pulse voltage Vedw of 1.2 V. Under the above conditions, the drive was performed 1,000 times, and the contrast of the opening portion (display portion) 171 was measured after the first drive and the 1,000th drive. The result was that the contrast was 10.6 after the first drive and 10.5 after the 1,000th drive, and there was no difference.

### Comparable Example 8

With respect to Example 3, the display updating interval tin was fixed to 1 s, the whitening pulse time tw was fixed to 4,600 ms, and the other conditions were the same. Under the above conditions, the drive was performed 1,000 times, and the contrast of the opening portion (display portion) 171 was measured after the first drive and the 1,000th drive. The result was that the contrast was 10.8 after the first drive, and this value was not much different from the result of Example 3. However, the contrast after the 1,000th drive was 2.2, and the display performance was apparently degraded.

### Comparable Example 9

With respect to Example 3, the whitening pulse time tw was fixed to 3,650 ms, and the other conditions were the same. Under the above conditions, the drive was performed 1,000 times, and the contrast of the opening portion (display portion) 171 was measured after the first drive and the 1,000th drive. The result was that the contrast was 10.5 after the first chive, and this value was not much different from the result of Example 3. However, after the 1,000th drive, bubbles were generated and the device was broken.

From the above results, it was confirmed that a method for driving an ED device which has excellent durability and in which the ED device is sufficiently whitened can provided by changing the whitening pulse time tw, depending on the display updating interval tin. Further, it was confirmed that the present embodiment was advantageous regardless of the composition of the electrolyte and the structure of the ED device 17 for evaluation.

### Example 4

In Example 4, the advantages of the negative reset method were confirmed by using the ED device 17 for evaluation of Example 1. The results are shown in Table 7.

TABLE 7

| | | | | | | | Contrast | | |
|---|---|---|---|---|---|---|---|---|---|
| | | | Whitening | Blackening | Blackening | | After | After | After |
| | Reset | Whitening Pulse | Pulse Voltage | Pulse Time | Pulse Voltage | Display Updating | first | 1000th | 10,000th |
| | Method | Time tw (ms) | Vedw (V) | tb (ms) | Vedb (V) | Interval tin (s) | drive | drive | drive |
| Example 4 | Negative | Whitening reaction | 1.2 | 800 | −1.5 | 1, 10, 60, 300, 1,800, | 5.1 | 5.3 | 5.2 |
| | Reset | time trw of | | | | 3,600 at random | | | |
| | | Table 1 +300 ms | | | | | | | |
| Example | Total | Whitening reaction | 1.2 | 800 | −1.5 | 1, 10, 60, 300, 1,800, | 10.1 | 9.1 | 5.1 |
| 1-1-1 | Reset | time trw of | | | | 3,600 at random | | | |
| | | Table 1 +300 ms | | | | | | | |

### Example 4

FIG. 15 shows how to connect lines for the evaluation of Example 4. In Example 4, the common electrodes R1-R50 and the even-numbered pixel electrodes C2-C50 are all connected to one line, which is connected to one terminal of the pulse power source PS. The odd-numbered pixel electrodes C1-C49 are also connected to one line, which is connected to the other terminal of the pulse power source PS.

With this way of connection, in Example 4, the pixels on the 25 odd-numbered columns repeat the white display and the black display, and the pixels on the 25 even-numbered columns remain the white display, and the negative reset method can be thus verified. The drive was performed 10,000 times with the other conditions being the same, and the contrast of the opening (display portion) 171 was measured after the first drive, the 1,000th drive, and the 10,000th drive. The result was that the contrast was 5.1 after the first drive, 5.3 after the 1,000th drive, and 5.2 after the 10,000th drive, and there was no difference.

The reason why the contrast of Example 4 was ½ of that of the Example 1-1 is that ½ of the pixels were driven, and the opening (display portion) 171 showed gray as a whole even when the black display was performed. For this reason, the contrast of the pixels repeating the white display and the black display can be thought to be two times the above result.

### Example 1-1-1

For the sake of comparison, Example 1, which was driven by a total reset method, was driven up to the 10,000th drive, and the contrast after the 10,000th drive was measured. The result was that the contrast was 10.1 after the first drive and 9.1 after the 1,000th drive, and they were not much different from only the pixels of Example 4 which repeat the white display and the black display. However, the contrast after the 10,000th drive was 5.1, and the display performance was apparently degraded.

### DESCRIPTION OF THE NUMERALS

1: Information display apparatus
2: Display control section
3: CPU
4: Display controller
5: Operation section
51: Forward operation section
52: Backward operation section
6: Storage section
8: Vcom drive circuit
9: Bus
10: Display section
11: Pixel
17: ED device
21: Source driver
31: Gate driver
101: Drive substrate
103: Common substrate
111: Pixel electrode
113: Common electrode
121: Electrolyte liquid layer
123: Electrolyte liquid
125: Silver ion
G1, G2, G3, G4: Gate signal
S1, S2, S3, S4: Source signal
Pmn: Pixel (atm-row, n-column)
Ss: Column selection signal
Sg: Row selection signal
Scom: Vcom drive signal
tin: Display updating interval
Pb: Blackening pulse
Pw: Whitening pulse
PRb: Blackening step
PRw: Whitening step
tb: Blackening pulse time
tk: Predetermined wait time
tw: Whitening pulse time
trw: Whitening response time
trb: Blackening response time
Vb: Blake display voltage
Vw: White display voltage
Vedb: Blackening pulse voltage
Vedw: Whitening pulse voltage
Icom: Common current
Vcom: Common voltage

1. A method for driving an electrochemical display device which includes a plurality of pixels arranged in a two-dimensional matrix, wherein display is performed by depositing metal in the pixels or by dissolving the metal deposited in the pixels by using an electrochemical reaction, the method comprising:
a blackening step for depositing the metal in the pixels by applying a blackening pulse to the pixels; and
a whitening step for dissolving the metal deposited in the pixels by applying a whitening pulse to the pixels,
wherein in the whitening step, one of or both of a voltage of the whitening pulse and an application time period of the whitening pulse are changed, depending on a time period having elapsed since the metal was deposited in the pixels in the blackening step.

2. The method of claim 1, wherein in the whitening step, when the time period having elapsed since the metal was deposited in the pixels is longer, an application time of the whitening pulse is set longer.

3. The method of claim 1, wherein in the whitening step, when the time period having elapsed since the metal was deposited in the pixels is longer, an application voltage of the whitening pulse is set higher.

4. The method of claim 1, wherein in the whitening step, the whitening pulse is applied only to the pixels in which metal has been deposited.

5. An information display apparatus comprising:
an electrochemical display device which has a plurality of pixels arranged in a two-dimensional matrix, wherein an display operation of the electrochemical display device is performed by depositing metal in the pixels or by dissolving the metal deposited in the pixels by using an electrochemical reaction; and
a display control section configured to control the display operation of the electrochemical display device, the display control section applying a blackening pulse to the pixels when depositing metal in the pixels, and applying a whitening pulse to the pixels when dissolving the metal deposited in the pixels, and the control section changing one of or both of a voltage of the whitening pulse and an application time period of the whitening pulse, depending on a time period having elapsed since the metal was deposited in the pixels by applying the blackening pulse.

6. The information display apparatus of claim 5, wherein when the time period having elapsed since the metal was deposited in the pixels is longer, an application time of the whitening pulse is set longer.

7. The information display apparatus of claim 5, wherein when the time period having elapsed since the metal was deposited in the pixels is longer, an application voltage of the whitening pulse is set higher.

8. The information display apparatus of claim 5, wherein the display control section applies the whitening pulse only to the pixels in which the metal is deposited.

9. The information display apparatus of claim 5, wherein the display control section includes two thin film transistors for one pixel to apply a voltage to the pixel.

10. The information display apparatus of claim 5, wherein the display control section includes a table which stores pairs of a voltage of the whitening pulse and an application time period of the whitening pulse, depending on a time period having elapsed, since the metal was deposited in the pixels by applying the blackening pulse.
